(19) United States
(12) Patent Application Publication
(10) Pub. No.: US 2026/0155905 A1
(43) Pub. Date: Jun. 4, 2026

(54) OPTICAL DEVICES FOR WAVELENGTH DIVISION MULTIPLEXING ACCORDING TO FREE SPECTRAL RANGE BASED WAVEBANDS

(71) Applicant: HEWLETT PACKARD ENTERPRISE DEVELOPMENT LP, Spring, TX (US)

(72) Inventor: Sagi Varghese MATHAI, Milpitas, CA (US)

(21) Appl. No.: 19/043,857

(22) Filed: Feb. 3, 2025

Related U.S. Application Data
(60) Provisional application No. 63/727,773, filed on Dec. 4, 2024.

(51) Int. Cl. H04J 14/02

(52) U.S. Cl. CPC H04J 14/02

(57) ABSTRACT

Systems and methods are provided for a waveband architecture in which waveband spacing can be adapted to accommodate varying numbers of wavelength channels per waveband. Examples include an optical source that generates an input light beam. The input light beam includes sets of optical signals within wavebands and the sets of optical signals include a plurality of optical signals at wavelengths within respective wavebands. Examples also include waveguides that receive the sets of optical signals, which are split amongst the plurality of waveguides according to the wavebands. Examples include sets of optical modulators coupled to the waveguides, where each optical modulator modulates an optical signal at a resonance wavelength of the respective optical modulator. The wavebands comprise a waveband spacing that is based on a free spectral range of the optical modulators. A multiplexer combines the modulated optical signals into a modulated output light beam.

### CROSS REFERENCE TO RELATED APPLICATIONS

This application claims the benefit of and priority to U.S. Provisional Patent Application No. 63/727,773, filed on Dec. 4, 2024, the contents of which are incorporated herein by reference in their entirety.

### BACKGROUND

Wavelength-division multiplexing (WDM) may refer to technologies that combine multiple optical signals of different wavelengths onto a common optical fiber. These optical signals may be transmitted simultaneously over the optical fiber via separate wavelength transmission channels (for concept illustration, these wavelength transmission channels may be viewed as separate lanes of a highway for different colors of light, e.g. a lane/transmission channel for green light, a lane/transmission channel for blue light, etc.).

There are two traditional approaches to WDM: Coarse Wavelength Division Multiplexing (CWDM) and Dense Wavelength Division Multiplexing (DWDM). CWDM uses wider wavelength transmission channel spacing than DWDM. For example, certain CWDM technologies space wavelength transmission passbands approximately 20 nanometers (nm) apart on the electromagnetic spectrum. These wavelengths may be referred to as CWDM wavelengths. DWDM generally uses a higher number of wavelength transmission channels per optical fiber than CWDM. DWDM may accommodate these additional channels by packing the channels more densely than CWDM. For example, DWDM wavelengths may be spaced approximately 0.4 nm or 0.8 nm apart (i.e., 25-50 times more closely than with CWDM).

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example of an optical communication system in which the examples of the present disclosure can be implemented.

FIG. 2 is an example diagram illustrating a waveband architecture, in accordance with various examples of the presently disclosed technology.

FIG. 3 depicts an example optical transmitter, in accordance with various examples of the presently disclosed technology.

FIG. 4 depicts another example optical transmitter, in accordance with various examples of the presently disclosed technology.

FIG. 5A-5D depicts an example optical receiver, in accordance with various examples of the presently disclosed technology.

FIG. 6 depicts another example optical receiver, in accordance with various examples of the presently disclosed technology.

FIG. 7 is a computing component that may be used to implement examples of the disclosed technology.

FIG. 8 depicts a block diagram of an example computer system in which various examples of the disclosed technology described herein may be implemented.

The figures are not exhaustive and do not limit the present disclosure to the precise form disclosed.

### DETAILED DESCRIPTION

Optical interconnects (e.g. composed of devices which transmit and receive signals from one location to another, respectively, using light) are often used in high performance computer networks as they are able to achieve high bandwidth over long distances with less power compared to electrical interconnects.

Pluggable optical transceiver modules are components in optical interconnects which may contain a coherent light source (e.g. a laser or a collection of lasers), an optical data transmitter (an optical device which can impart data onto an optical signal by modulating the optical signal) and an optical receiver (an optical device which can obtain the transmitted data by detecting the modulated optical signals) in the same physical package. Certain pluggable optical transceiver modules may be designed to operate with the CWDM standard. In particular, they are designed to produce, modulate, and detect a single wavelength (within a certain tolerance value) per CWDM passband. Utilizing an industry standard 100 Gigabit (G) serializer/deserializer (SERDES), these CWDM modules may achieve data transmission rates of approximately 400 Gigabits per second (Gbps) (i.e., 100 G×4 wavelength transmission channels) per optical fiber.

It is expected that future networks may require higher data transmission rates (e.g., 800 Gbps or more). Certain CWDM pluggable optical transceiver modules may be designed to achieve these higher rates using the SERDES standard of 100 G. For example, certain approaches to CWDM pluggable optical transceiver modules propose adding additional wavelength transmission channels within the CWDM passbands to achieve higher data transmission rates.

However, there is a limit to the number of wavelength transmission channels that can be added within each CWDM passband, which restricts the achievable data transmission rates. This is because when data is imparted onto an optical signal, the optical signal's spectrum becomes wider. As the data transmission rate increases, the optical signal's spectrum likewise increases. The widened optical signals may overlap/interfere, resulting in cross talk and higher bit error rates. In applications utilizing CWDM passbands that are separated by 20 nm, the passbands may be fixed and thus the number of wavelength channels that can be run at the 100 Gbps SERDES standard are limited by the widening of the optical signal's spectrum. Additionally, running individual wavelength transmission channels at 100 Gbps can be expensive in terms of power consumption due to a proportional relationship between data transmission speed and power needed to drive the transmission. As such, utilizing the 100 Gbps SERDES standard per wavelength channel results in relatively higher power consumption.

Against this backdrop, examples of the presently disclosed technology provides bandwidth scaling (i.e., higher data transmission rates) by utilizing a flexible waveband architecture in which waveband spacing can be adapted to accommodate a varying number of wavelength channels per waveband. A waveband, as used herein, may refer to two or more discrete wavelengths within a passband. A passband may refer to a spectrum (or range) of wavelengths that can pass through an optical filter. As used herein, a wavelength channel may refer to a discrete wavelength within a waveband. An optical signal may be communicated via a wavelength channel by encoding data onto light propagating at the discrete wavelength of the wavelength channel.

By accommodating varying numbers of wavelength channels per waveband, higher data transmission rates (e.g., 800 Gbps or more) can be achieved in the aggregate while running individual wavelength channels at relatively lower data transmission rates. For example, while wavelength channels can be run at any desired data rate, in particular examples, the individual wavelength channels can be run at less than the 100 Gbps SERDES standard. In one illustrative example, wavelength channels can be run at 50 Gbps, resulting in a per-waveband transmission rate of N times 50 Gbps, where N is the number of wavelength channels within a given waveband. In the case of each waveband comprising four wavelength channels, each waveband can achieve data transmission rates of 200 Gbps and four wavebands can provide an aggregate data transmission rate of 800 Gbps. Due to wavelength channels operating at 50 Gbps, less power can be consumed as compared to the 100 Gbps SERDES standard. While the above example specifies data rates of 50 Gbps, examples disclosed herein are not limited to this example and other data rates may be used as desired. For example, a data rate of 64 Gbps may be utilized in some implementations. Additionally, examples herein are not limited to four wavebands and four wavelength channels. Any number of wavebands may be provided, each comprising two or more wavelength channels based on certain constraints as detailed below.

In examples, the present disclosure provides an optical transmitter that comprises a plurality of waveguides having a set of optical modulators optically coupled thereon. For example, each waveguide may comprise a set of optical modulators coupled thereto, where each optical modulator can be designed for a different resonance wavelength. An optical source may emit and input a light beam having a set of optical signals within respective wavebands. Each set of optical signals includes a plurality of optical signals at wavelengths within the respective waveband (e.g., four optical signals at four wavelengths within the respective waveband in an illustrative example). The input light beam can be split amongst the waveguides according to the wavebands, for example by a waveband demultiplexer, such that each waveguide receives a set of the optical signals within a single waveband. The optical modulators can then be driven to encode data onto the set of optical signals by modulating an optical signal at a wavelength that corresponds to the resonance wavelength of the optical modulator. A waveband multiplexer can be coupled to waveguides that combine the modulated optical signals from the sets of optical modulators into a modulated output light beam, which can be transmitted for downstream processing.

Spacing between each waveband is based on the free spectral range (FSR) of the optical modulators. For example, the spacing between wavebands may be equal to or greater than the shortest FSR of the optical modulators. In this way, the wavebands can be spaced as desired according to the FSRs of the optical modulators. By using optical modulators that have larger FSRs, the aggregate data transmission rate can be increased by widening the spacing between the wavebands accordingly and adding additional wavelength channels within the wavebands. Accordingly, examples of the present disclosure can achieve reduced power consumption by using slower data rates (e.g., less than 100 Gbps, such as 64 or 50 Gbps), which permits smaller spacing between wavelength channels and increasingly denser numbers of wavelength channels per each waveband. To achieve collectively higher data rates, increased numbers of wavelength channels can be used which is enabled due to the smaller spacing between channels, as well as wider spacing between each waveband. For example, referring to the above example, four wavelength channels per waveband can collectively achieve 800 Gbps (e.g., 50 Gbps per channel times four channels per waveband times four wavebands) or more. Thus, the present disclosure can achieve similar aggregate data transmission rates to those achievable using the 100 Gbps SERDES standard with reduced power consumption.

In some examples, the optical source may be one or more comb lasers that emit the input light beam. In an example, a single comb laser may be used, which can provide the input light beam to the waveband demultiplexer. The waveband demultiplexer splits the input light beam into a plurality of post-demultiplexed light beams and each of the plurality of post-demultiplexed light beams comprises a set of the optical signals fed to a respective waveguide. In another example, the optical source may include a plurality of comb lasers that collectively emit the input light beam as a plurality of input light beams. In this case, each input light beam comprises a set of optical signals within a waveband of the plurality of wavebands and is supplied to a respective waveguide.

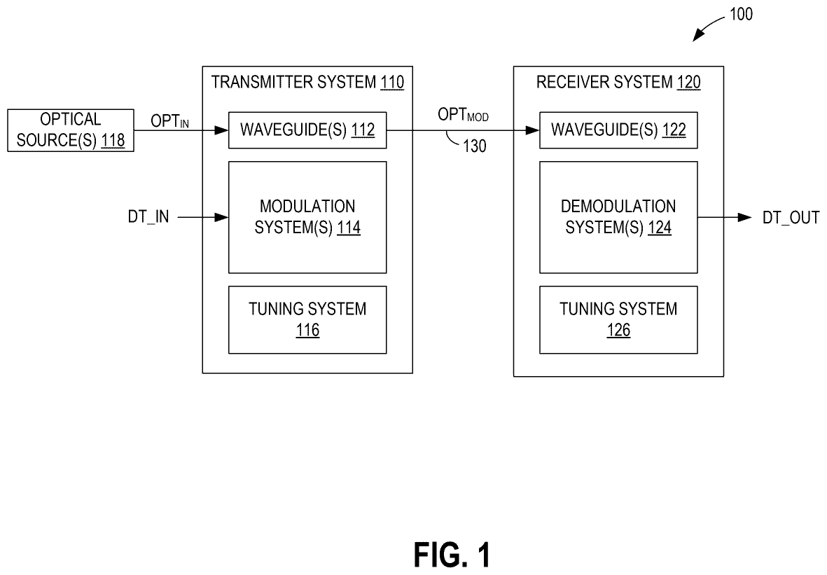

FIG. 1 illustrates an example of an optical communication system 100 in which the examples of the present disclosure can be implemented. The optical communication system 100 can be implemented in any of a variety of optical communications applications to transmit data. The optical communication system 100 includes a transmitter system 110 and a receiver system 120 that can be coupled to each other via an optical transmission medium 130. As an example, the optical transmission medium 130 can be configured as any of a variety of different types of optical transmission media, such as an optical fiber (e.g., fiber optic cable), waveguide, or a variety of other media through which an optical signal can propagate. As an example, the optical communication system 100 can be implemented as an optical interconnect system for optical communication between separate electronic devices.

The transmitter system 110 can be configured to receive and modulate an optical signal OPT_{IN} based on one or more input data signals DT_IN, and provide the modulated optical signal, demonstrated in the example of FIG. 1 as an optical signal OPT_{MOD}, to the receiver system 120. In an example, the transmitter system 110 can be configured to implement wavelength division multiplexing (e.g., DWDM and/or CWDM) of the optical signal OPT_{IN}. The receiver system 120 can be configured to receive the modulated optical signal OPT_{MOD} and to demodulate the modulated optical signal OPT_{MOD} to provide one or more data output signals, demonstrated in the example of FIG. 1 as output data signals DT_OUT.

The transmitter system 110, in the example of FIG. 1, includes one or more waveguide(s) 112 that can be configured to receive the optical signal OPT_{IN}. As an example, the optical signal OPT_{IN} can be generated by one or more optical sources 118 as a multi-wavelength optical signal. In examples, the optical source(s) 118 may be one or more comb lasers that can emit light having optical signals as a series of equally spaced spectral lines (e.g., a series of optical signals at equally spaced wavelengths). Alternatively, the optical source(s) 118 may comprise a laser bank (e.g., a distributed feedback (DFB) laser bank) or any other coherent light source configured to emit multi-wavelength light consisting of optical signals at multiple wavelengths. In examples, the optical signal OPT_{IN} may be a beam of light comprising a set of optical signals within a plurality of wavebands. The set of optical signals may be individual optical signals at distinct wavelengths within a respective waveband. For example, the distinct wavelengths may be discrete and regularly spaces spectral lines of the electromagnetic spectrum. Thus, in this case, the optical signal OPT_{IN} may be referred to as an aggregate optical signal and the individual optical signals that make up the aggregate optical signal may be referred to as discrete optical signals at a respective wavelength.

The transmitter system 110 may also include one or more modulation system(s) 114 that are configured to modulate the optical signal OPT_{IN} propagating in the waveguide(s) 112 based on the input data signal(s) DT_IN. As an example, the modulation system(s) 114 can include one or more optical modulators that can be optically coupled (e.g., evanescently or otherwise photonically coupled) to the one or more waveguide(s) 112. The optical modulators may be configured to modulate the optical signal OPT_{IN} via one or more of a plasma dispersion effect, an electro-optic effect, an electro-absorption, or the like as known in the art. The optical modulators may be implemented as optical resonators, such as microring resonators (MRRs) or other types of resonators, such as but not limited to, racetrack and whispering gallery mode resonators. An optical resonator may have an initial resonance wavelength (λ0) defined by a round-trip length of the optical resonators. In the case of MRRs, each MRR can have a radius corresponding to an initial resonant wavelength (λ0).

The optical signal OPT_{IN} may include discrete optical signals at wavelengths of the initial resonant wavelengths of the optical modulators. Thus, in this case, the optical modulators of the modulation system(s) 114 can be configured to modulate a respective wavelength of the optical signal OPT_{IN} in response to the input data signal(s) DT_IN. Therefore, the modulated optical signal OPT_{MOD} can correspond to the optical signal OPT_{IN} that is modulated via the input data signal(s) DT_IN.

In examples, each optical modulator, implemented as an optical resonator, comprises a plurality of resonance wavelengths separated by the FSR of the respective modulator. Thus, a given optical modulator may resonant at its respective initial resonance wavelength (λ₀) and its respective resonance modes (e.g., λ₁, λ₂, λ₃, . . . , λₘ) separated by its respective FSR. The optical signal OPT_{IN} may be based on the number of optical modulators and FSRs of one or more of the optical modulators. For example, as described above, the optical signal OPT_{IN} may comprise a number of discrete optical signals at a number of discrete wavelengths. The discrete optical signals may be grouped into separate wavebands. The wavebands may comprise a portion of the electromagnetic spectrum (e.g., a range of wavelengths). The range of wavelengths, which can define a spectral width of a respective waveband, can be configured according to the FSR of at least one optical modulator. That is, for example, the wavebands may be separated by the FSR of at least one optical modulator, such that the ranges of wavelengths that constitute the wavebands comprise one discrete optical signal of each optical modulator. In some examples, the spectral widths of the wavebands may be dependent upon the smallest FSR of the optical modulators. Thus, in this case, the optical modulators of the modulation system(s) 114 can be configured to resonate respective wavelengths of the optical signal OPT_{IN} in response to the input data signal(s) DT_IN to modulate the optical signal OPT_{IN} by modulating the respective resonance wavelengths (e.g., λ₀, λ₁, λ₂, . . . , λₘ) from the optical signal OPT_{IN}.

In the example of FIG. 1, the transmitter system 110 can also include a tuning system 116. The optical modulators in each of the modulation system(s) 114 can be rendered susceptible to fabrication variations and environmental fluctuations based on specific wavelength-selectivity. Therefore, the tuning system 116 can be implemented to wavelength-shift the resonance wavelengths of the optical modulators included in the modulation system(s) 114. Such shifts in resonance wavelengths may mitigate wavelength drifts that can occur with respect to each of the modulation system(s) 114, such as resulting from fabrication variations and/or environmental fluctuations (e.g., temperature). Such shifts in resonance wavelengths may also mitigate wavelength drifts that can occur in the optical source 118.

As an example, the tuning system 116 can be configured to induce such wavelength-shifts based on feedback from the modulation system(s) 114. For example, the tuning system 116 can be configured to monitor an intensity of a portion of an optical signal resonating in the optical modulator associated with the respective one of the modulation system(s) 114. When the intensity is below a threshold level indicative of a wavelength drift, the tuning system 116 may be configured to adjust a bias signal(s) (e.g., voltage bias) associated with tuning mechanism(s) (also referred to herein as tuning mechanism(s)) to induce a change in a resonance wavelength that mitigates the wavelength drift. Mitigating such drifts can ensure the optical modulators can modulate the optical signal OPT_{IN} at the respective wavelength according to input data signal DT_IN. Thus, the tuning system 116 can provide rapid tuning mechanisms that induces a change in the resonance wavelength of the optical modulators. In addition, the tuning system 116 can also include other tuning mechanisms, such as thermal tuning, to provide greater tuning flexibility.

The receiver system 120 may include one or more waveguide(s) 122 that are configured to receive the modulated optical signal OPT_{MOD}. The receiver system 120 also can include one or more demodulation system(s) 124 that are configured to demodulate the modulated optical signal OPT_{MOD} propagating in the one or more waveguide(s) 122 to provide the output data signal(s) DT_OUT.

As an example, each of the demodulation system(s) 124 can include one or more optical detectors that can be optically coupled (e.g., evanescently or otherwise photonically coupled) to the one or more waveguide(s) 122. The optical detectors may be implemented as optical resonators, similar to those described above in connection with the transmitter system 110. The optical detectors may have initial resonance wavelengths (λ₀) defined by a round-trip length of the optical detector and multiple resonance modes (e.g., λ₁, λ₂, λ₃, . . . , λₘ) separated by respective FSRs corresponding to a wavelengths of the modulated optical signal OPT_{MOD}. Thus, the optical detector of the respective one of the demodulation system(s) 124 can be configured to resonate at the respective wavelengths of the modulated optical signal OPT_{MOD} to provide the respective output data signal(s) DT_OUT.

In the example of FIG. 1, the receiver system 120 can also include a tuning system 126. As described previously, optical detectors, such as the ring resonators, in each of the demodulation system(s) 124 can be susceptible to fabrication variations and environmental fluctuations based on specific wavelength-selectivity. Therefore, the tuning system 126 can be implemented to mitigate wavelength drifts that can occur with respect to the demodulation system(s) 124, such as resulting from fabrication variations and/or environmental fluctuations (e.g., temperature). The tuning system 126 can operate substantially similar to the tuning system 116 of the transmitter system 110.

The optical communication system 100 can be implemented as an optical interconnect system for optical communication between separate electronic devices. For example, the transmitter system 110 and/or the receiver system 120 of the optical communication system 100 can be implemented on an integrated circuit (IC) chip, or as a combination of chips. As another example, the optical communication system 100 can be implemented in a transceiver system, such that the transmitter system 110 and the receiver system 120 are not coupled via the optical transmission medium 130, but are instead both arranged on a single IC chip or package to respectively transmit and receive modulated optical signals individually. For example, the optical communication system 100 can be implemented as a transceiver IC that includes a complementary metal-oxide semiconductor (CMOS) chip that is flip-chip bonded to a photonic chip to provide optical communication capability. Accordingly, the optical communication system 100 can be implemented in a variety of ways.

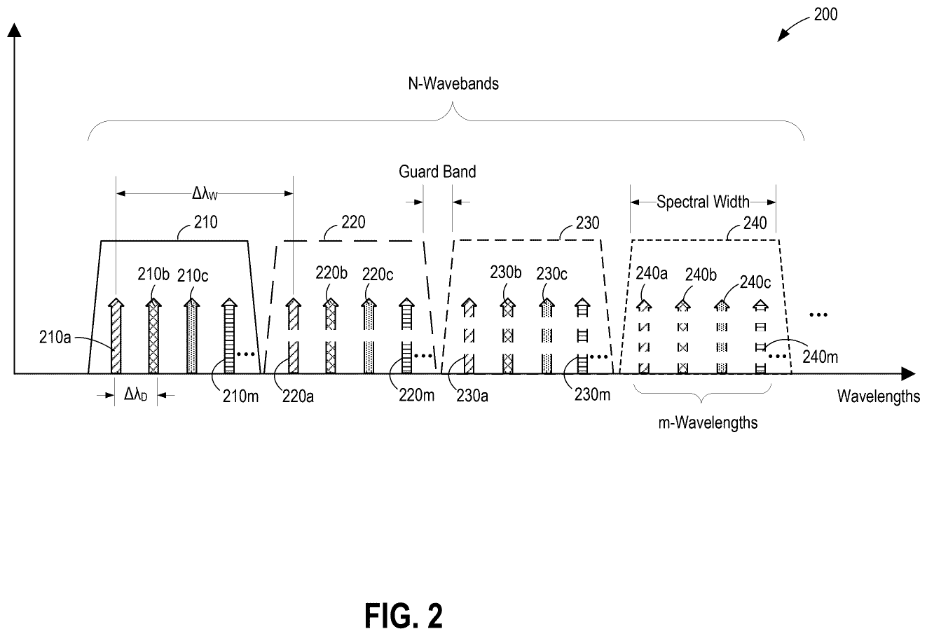

FIG. 2 is an example diagram illustrating a waveband architecture 200, in accordance with various examples of the presently disclosed technology. As depicted, waveband architecture 200 is comprised of four wavebands. However, in other examples a waveband architecture may be comprised of two or more wavebands depending on the desired application.

As described above, a waveband may refer to a number of wavelengths within a passband. A passband may refer to a spectrum of wavelengths that can pass through an optical filter. The wavebands, may be spaced approximately Δλ_{W} apart on the electromagnetic spectrum and separated by a guard band. In examples, Δλ_{W} may be based on an FSR of an optical resonator that can be used to encode data onto an optical signal (e.g., optical modulators of modulation system 114). In examples, Δλ_{W} may be equal to or greater than an FSR. In the example of FIG. 1, the wavebands are spaced one FSR apart such that Δλ_{W}=FSR. Each waveband may be a spectrum of wavelengths that includes an mth resonance mode wavelength of a set of optical modulators, where m is an integer from 0 to m (e.g., λ₀, λ₁, λ₂, . . . , λₘ).

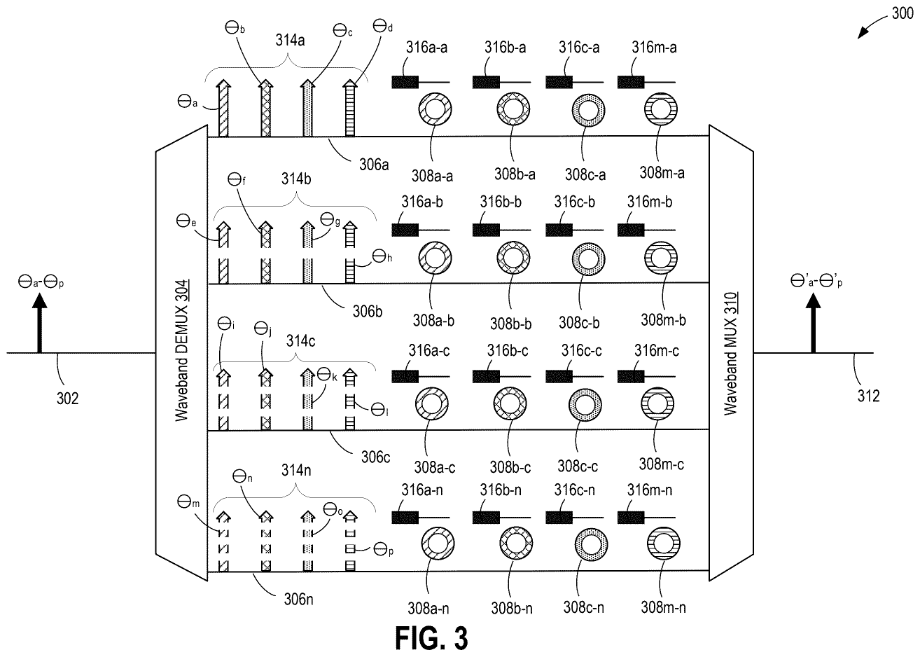

As shown in FIG. 2, waveband 210 is comprised of four wavelengths spaced approximately Δλ_{D} apart: wavelengths 210a, 210b, 210c, and 210m. In other examples, waveband 210 may be comprised of any number m of wavelengths spaced apart by Δλ_{D} or by varying distances. The number of wavelengths 210a-210m may be based on how many optical modulators are to receive waveband 210. For example, as will be described below in detail with respect to FIGS. 3-6, four optical modulators may receive an optical signal comprising waveband 210. Waveband 210 may be constructed to include at least one resonance wavelength corresponding to each optical modulator. In the example of FIG. 2, waveband 210 may comprise the initial resonance wavelengths of four optical modulators: wavelengths 210a, 210b, 210c, and 210m. The initial resonance wavelengths may be spaced apart by a common distance (e.g., Δλ_{D}) or different distances depending on the desired application. While the example of FIG. 2 depicts four discrete wavelengths, examples herein may include two or more wavelengths dependent upon the number of optical modulators that will receive the waveband.

The waveband 210 may be centered at approximately a midpoint of the wavelengths 210a-210m and may have a width that is equal to or wider than the spectral range defined by the wavelengths 210a-210m. In examples, the waveband may have a width and center defined by the passband, which may be designed to achieve the above-described dimensions relative to the desired wavelengths to be included in the waveband.

Wavebands 220, 230, and 240 are also comprised of wavelengths in a manner similar to waveband 210. For example, waveband 220 includes wavelengths 220a, 220b, 220c, and 220m; waveband 230 includes wavelengths 230a, 230b, 230c, and 230m; waveband 240 includes wavelengths 240a, 240b, 240c, and 240m. As described above, the number of wavelengths included in each waveband 220-240 may be based on how many optical modulators are to receive a respective waveband. In the example of FIG. 2, each waveband 220-240 may comprise a resonance wavelength of four optical modulators and spaced apart by approximately Δλ_{D} or different distances depending on the desired application. For example, waveband 220 may comprise the first resonance wavelengths (λ₁) 220a-220m of the four optical modulators; waveband 230 may comprise the second resonance wavelengths (λ₂) 230a-230m of the four optical modulators; and waveband 240 may comprise the third resonance wavelength (λ₃) 240a-240m of the four optical modulators. Similar to waveband 210, wavebands 220, 230 and 240 can be centered and have widths configured as described above in connection with waveband 210.

Waveband architectures such as waveband architecture 200 can be leveraged to provide a flexible waveband architecture in which waveband spacing can be adapted to accommodate a varying number of wavelength channels per waveband based on the FSR of optical modulators that can be used for imparting data thereon. As described above, wavebands can be scaled as desired according to an FSR of at least one optical modulator. By using an optical modulator having larger FSRs, the aggregate data transmission rate can be increased by widening the spacing between the wavebands accordingly and adding additional wavelength channels within the wavebands. Accordingly, waveband architecture 200 can be used to achieve reduced power consumption by using slower data rates (e.g., less than 100 Gbps, such as 64 or 50 Gbps), which permits smaller spacing between wavelength channels and increasingly denser numbers of wavelength channels per waveband. To achieve collectively higher data rates, increased numbers of wavelength channels can be used which is enabled due to the smaller spacing between channels, as well as wider spacing between each waveband. In the example of FIG. 3, four wavelength channels per waveband can collectively achieve 800 Gbps (e.g., 50 Gbps per channel times four channels per waveband times four wavebands) or more. Optical communication systems, such as optical communication system 100, can achieve similar aggregate data transmission rates to those achievable using the 100 Gbps SERDES standard with reduced power consumption, as described above.

FIG. 3 depicts an example optical transmitter 300, in accordance with various examples of the presently disclosed technology. Optical transmitter 300 may be an example implementation of the transmitter system 110 of FIG. 1. Optical transmitter 300 includes an input waveguide 302, waveband demultiplexer (DEMUX) 304, a plurality of waveband waveguides 306a-306n, a plurality of optical modulators 308a-a through 308n-m, waveband MUX 310, and output waveguide 312.

In the example of FIG. 3, the optical transmitter 300 may receive optical signals of one or more wavebands on input waveguide 302 from an optical source, such as optical source 118 of FIG. 1. These wavebands may be comprised of two or more wavelengths. For example, the wavebands may be received according to the waveband architecture 200 described above in connection with FIG. 2.

Here, optical transmitter 300 may receive 16 optical signals of 16 different wavelengths on a single input waveguide 302 (i.e., optical signals ⊖ₐ-⊖ₚ). These sixteen different wavelengths may comprise four wavebands of four wavelengths each. For example, the wavelengths of optical signals ⊖ₐ-⊖_{d} may comprise a first waveband; the wavelengths of optical signals ⊖ₑ-⊖ₕ may comprise a second waveband; the wavelengths of optical signals ⊖ᵢ-⊖ₗ may comprise a third waveband; and the wavelengths of optical signals ⊖ₘ-⊖ₚ may comprise a fourth waveband. In other examples, optical transmitter 300 may receive optical signals of a different number of wavebands (e.g., optical signals of two wavebands, three wavebands, five wavebands, etc.). Similarly, the wavebands may be comprised of fewer or additional wavelengths (e.g., two wavelengths per waveband, three wavelengths per waveband, five wavelengths per waveband, etc.). In examples, the light beam comprising ⊖ₐ-⊖ₚ (e.g., an aggregate optical signal) may be an example of optical signal OPT_{IN} and the individual optical signals ⊖ₐ-⊖ₚ may be examples of discrete optical signals propagating at a respective wavelength.

In the specific example of FIG. 3, optical transmitter 300 receives optical signals of four wavebands, where each waveband is comprised of four wavelengths. Said differently, optical transmitter 300 may receive 16 optical signals on a single input waveguide 302. Accordingly, optical transmitter 300 may operate with any of the waveband light sources described in conjunction with FIG. 1.

As depicted in FIG. 3, optical signals ⊖ₐ-⊖ₚ, shown for illustrative purposes as a single aggregate signal, are received by optical transmitter 300 and carried to waveband DEMUX 304. As a reciprocal device to an optical MUX, an optical DEMUX (such as waveband DEMUX 304) may split a light beam into two or more light beams based on wavelength/waveband. Said differently, an optical DEMUX may receive multiple optical signals of different wavelengths/wavebands traveling on a common waveguide (e.g., input waveguide 302), and split the optical signals according to wavelength/waveband onto separate waveguides. As used herein, a waveband demultiplexer (such as waveband DEMUX 304) may refer to an optical demultiplexer that splits an input light beam by waveband. For example, a waveband demultiplexer may split an input light beam comprised of optical signals of multiple wavebands, into separate light beams comprised of optical signals of the individual wavebands. The waveband demultiplexers may be, but not limited to, lattice filter demultiplexers, echelle gratings, and arrayed waveguide gratings, which can be constructed/sourced from readily available or modifications to silicon photonic foundry process design kits.

In the case of FIG. 3, waveband DEMUX 304 may split optical signals ⊖ₐ-⊖ₚby waveband onto four separate waveband waveguides 306a-306n (i.e., waveband DEMUX 304 may split the received single light beam into four wavebands 314a-314n). In the example of FIG. 3, waveband DEMUX 304 may split optical signals ⊖ₐ-⊖_{d} of first waveband 314a onto a first waveband waveguide 306a; optical signals ⊖ₑ-⊖ₕ of second waveband 314b onto a second waveband waveguide 306b; optical signals ⊖ᵢ-⊖ₗ of third waveband 314c onto a third waveband waveguide 306c; and optical signals ⊖ₘ-⊖ₚ of fourth waveband 314n onto a fourth waveband waveguide 306n. These waveband waveguides 306a-306n may carry the optical signals (sometimes referred to herein as post-demultiplexed optical signals) to optical modulators 308a-a through 308m-n.

As described above, an optical modulator may be an optical device that can be driven to impart data onto an optical signal by modulating the optical signal. Each optical modulator may be calibrated to modulate optical signals of a certain wavelength. For example, optical modulator 308a-a may be calibrated to modulate the wavelengths of optical signal ⊖ₐ, optical modulator 308b-a may be calibrated to the wavelengths of optical signal ⊖_{b}, optical modulator 308c-a may be calibrated to the wavelengths of optical signal ⊖_{c}, optical modulator 308m-a may be calibrated to the wavelengths of optical signal ⊖_{d}, etc. Accordingly, optical modulators 308a-a through 308m-n may impart separate packets of data onto optical signals ⊖ₐ-⊖ₚ, respectively. These modulated optical signals may be represented as optical signals ⊖′ₐ-⊖′ₚ, respectively.

Optical modulators 308a-a through 308m-n may be various types of optical modulators. In the illustrative example of FIG. 3, optical modulators 308a-a through 308m-n are MRRs. In other examples, they may be, but not limited to, racetrack and whispering gallery mode resonator based optical modulators. The MRRs 308a-a through 308m-n may be coupled to the waveband waveguides 306a-306n. In particular, MRRs 308a-a through 308m-a may be coupled to the waveband waveguide 306a, MRRs 308a-b through 308m-b may be coupled to the waveband waveguide 306b, MRRs 308a-c through 308m-c may be coupled to the waveband waveguide 306c, and MRRs 308a-n through 308m-n may be coupled to the waveband waveguide 306n.

A MRR may be an optical device that imparts data onto an optical signal by modulating the optical signal. Here, each MRR may be tuned to modulate optical signals of a certain wavelength, while allowing optical signals of different wavelengths to pass undisturbed. For example, MRR 308a-a may be tuned to modulate wavelengths of optical signal ⊖ₐ, as described above, while allowing optical signals of other wavelengths (e.g., wavelengths of optical signals ⊖_{b}-⊖_{d}) to pass undisturbed. Similarly, MRR 308b-a may be tuned to modulate wavelengths of optical signal ⊖_{b}, as described above, while allowing optical signals of other wavelengths (e.g., wavelengths of optical signals ⊖ₐ, ⊖_{c}, and ⊖_{d}) to pass undisturbed. The other MRRs depicted may be tuned in the same/similar fashion. Accordingly, these 16 MRRs may be respectively tuned to modulate optical signals ⊖ₐ-⊖ₚ. In various examples, these MRRs may be sourced or custom designed from readily available silicon photonic foundry process design kits.

As described above, MRRs 308a-a through 308m-n may be tuned to modulate optical signals of a certain wavelength. This certain wavelength may be an initial resonance wavelength. As such, as detailed above, the MRRs 308a-a through 308m-n may be also resonant at a plurality of resonance wavelengths separated by a respective FSR. Thus, the MRRs 308a-a through 308m-n may be tuned to modulate an initial resonance wavelength and respective resonance modes, while allowing optical signals of different wavelengths to pass undisturbed. The aggregate optical signal (e.g., ⊖ₐ-⊖ₚ as a single optical signal) may be based on the number of MRRs implemented in the optical transmitter 300 and the FSRs of one or more of the MRRs.

For example, as described above, optical signals ⊖ₐ-⊖ₚ can be grouped into wavebands 314a-314n. The spectral width of the wavebands 314a-314n can be configured according to the FSR of at least one MRR. That is, as described above in connection with FIGS. 1 and 2, the wavebands 314a-314n may be separated by at least the FSR of at least one MMR 308 a-a through 308m-n, such that the ranges of wavelengths of optical signals ⊖ₐ-⊖ₚ that are included in each waveband 314a-314n comprise a discrete optical signal of each optical modulator. For example, as described above, waveband 314a may comprise optical signals ⊖ₐ-⊖_{d}, waveband 314b may comprise optical signals ⊖ₑ-⊖ₕ; waveband 314c may comprise optical signals ⊖ᵢ-⊖ₗ; and waveband 314n may comprise optical signals ⊖ₘ-⊖ₚ. Optical signal ⊖ₐ may be propagating at the initial resonance wavelength of MRR 308a-a and optical signals ⊖ₑ, ⊖ᵢ, and ⊖ₘ may be propagating at a resonance mode wavelength of MRR 308a-a. Similarly, optical signal ⊖_{b} may be propagating at the initial resonance wavelength of MRR 308b-a and optical signals ⊖_{f}, ⊖ⱼ, and ⊖ₙ may be propagating at a resonance mode wavelength of MRR 308b-a; optical signal ⊖_{c} may be propagating at the initial resonance wavelength of MRR 308c-a and optical signals ⊖_{g}, ⊖ₖ, and ⊖ₒ may be propagating at a resonance mode wavelength of MRR 308c-a; and optical signal ⊖_{d} may be propagating at the initial resonance wavelength of MRR 308m-a and optical signals ⊖ₕ, ⊖ₗ, and ⊖ₚ may be propagating at a resonance mode wavelength of MRR 308m-a.

The initial resonance wavelength and the FSR of an MRR may be defined by a round-trip length of the MRR. Accordingly, in some examples, the subsets of MRRs 308a-a through 308m-n may have common round-trip lengths and construction (e.g., materials and operating parameters). In this case, the MRRs of a given subset may share a common initial resonance wavelength and common resonance mode wavelengths. In a particular example, a first subset of MRRs, comprising MRRs 308a-a, 308a-b, 308a-c, and 308a-n, may be to tuned to modulate wavelengths of optical signal ⊖ₐ as the initial resonance wavelength and wavelengths of optical signals ⊖ₑ, ⊖ᵢ, and ⊖ₘ as resonance mode wavelengths. As such, MRRs 308a-b, 308a-c, and 308a-n may be instances of MRR 308a-a coupled to respective waveband waveguides 306b-306n, as shown. Similarly, a second subset of MRRs, comprising MRRs 308b-a, 308b-b, 308b-c, and 308b-n, may be to tuned to modulate wavelengths of optical signal ⊖_{b} as the initial resonance wavelength and wavelengths of optical signals ⊖_{f}, ⊖ⱼ, and ⊖ₙ as resonance mode wavelengths; a third subset of MRRs, comprising MRRs 308c-a, 308c-b, 308c-c, and 308c-n, may be to tuned to modulate wavelengths of optical signal ⊖_{c} as the initial resonance wavelength and wavelengths of optical signals ⊖_{g}, ⊖ₖ, and ⊖ₒ as resonance mode wavelengths; and a fourth subset of MRRs, comprising MRRs 308m-a, 308m-b, 308m-c, and 308m-n, may be to tuned to modulate wavelengths of optical signal ⊖_{d} as the initial resonance wavelength and wavelengths of optical signals ⊖ₕ, ⊖ₗ, and ⊖ₚ as resonance mode wavelengths.

Optical transmitter 300 also includes monitor photodetectors 316a-a through 316m-n, respectively. A monitor photodetector may refer to as an optical device that can detect modulated or unmodulated optical signals of a certain wavelength (or wavelengths). For example, monitor photodetector 316a-a a may be tuned to detect the wavelength of modulated optical signal ⊖′ₐ, photodetector 316b-a may be tuned to detect the wavelength of modulated optical signal ⊖′_{b}, photodetector 316b-c may be tuned to detect the wavelength of modulated optical signal ⊖′_{c}, etc. Here, the monitor photodetectors may be included in optical transmitter 300 in order to monitor and set the bias point of the MRRs. The monitor photodetectors 316a-a through 316m-n may receive a respective modulated optical signal via a respective waveguide that is optically coupled (e.g., evanescently or otherwise photonically coupled) to a corresponding MRR 308a-a through 308m-n, as shown in FIG. 3. In various examples, these monitor photodetectors may be sourced or custom designed from readily available silicon photonic foundry process design kits.

In other examples, the monitor photodetector may be incorporated into a section of the MRRs. For example, an MRR may include an absorbing structure within or adjacent to its waveguide that can be used to detect light intensity. A monitoring circuit can be electrically coupled to the in-situ absorbing structure to generate an electrical signal indicative of the light intensity detected by the in-situ absorbing structure. Illustrative examples of absorbing structures integrated into a MRR are described in U.S. Pat. Nos. 11,442,235 and 11,927,819, each assigned to the Applicant and the disclosures of which are incorporated herein by reference.

Modulated optical signals ⊖′ₐ-⊖′ₚ may be carried to waveband MUX 310. As described above, MUXs may refer to optical devices that combine optical signals of different wavelengths onto common waveguides. As used herein, a waveband multiplexer may refer to an optical multiplexer which combines two or more light beams by waveband. For example, a waveband multiplexer may combine a first light beam comprised of optical signals of a first waveband with a second light beam comprised of optical signals of a second waveband—into a common light beam. Waveband multiplexers may be, but not limited to, lattice filters, echelle gratings, MRRs, and/or array waveguide grating multiplexers, which can be constructed/sourced from readily available silicon photonic foundry process design kits.

Waveband MUX 310 may combine the modulated optical signals of the four wavebands onto a single output waveguide 312. As will be described below, these modulated optical signals ⊖′ₐ-⊖′ₚ, shown as a single aggregate signal for illustrative purposes, may be an example of the modulated optical signal OPT_{MOD} of FIG. 1, which can be carried to an optical receiver (e.g., receiver system 120 of FIG. 1). The optical receiver can operate to detect and decode the modulated optical signals. This may correspond to “reading/extracting” the data imparted onto the modulated optical signals.

The example of FIG. 3 illustrates an implementation in which four wavebands are modulated. However, as noted above, optical transmitter 300 may receive optical signals of a different number of wavebands (e.g., optical signals of two wavebands, three wavebands, five wavebands, etc.). To accommodate more or fewer wavebands, optical transmitter 300 can be configured with more or fewer waveguides between the waveband DEMUX 304 and waveband MUX 310. For example, since the example of FIG. 3 is described in connection with four wavebands, four waveband waveguides 306a-306n are shown. To add additional wavebands, addition instances of waveband waveguides 306a-306n can be added, each optically coupled to additional optical modulators configured to modulate wavelengths of optical signals contained within the additional wavebands.

Similarly, the example of FIG. 3 illustrates an implementation in which each waveband comprises four wavelengths. However, as noted above, each waveband may comprise a different number of wavelengths. To accommodate more or fewer wavelengths, additional or fewer optical modulators can be coupled to each waveband waveguide 306a-306n depending on the number of wavelengths. For example, since the example of FIG. 3 is described in connection with four wavelengths, four optical modulators are shown coupled to each respective waveband waveguide 306a-306n. To add additional wavelengths, additional optical modulators can be added, each tuned to modulate wavelengths of the additional optical signals.

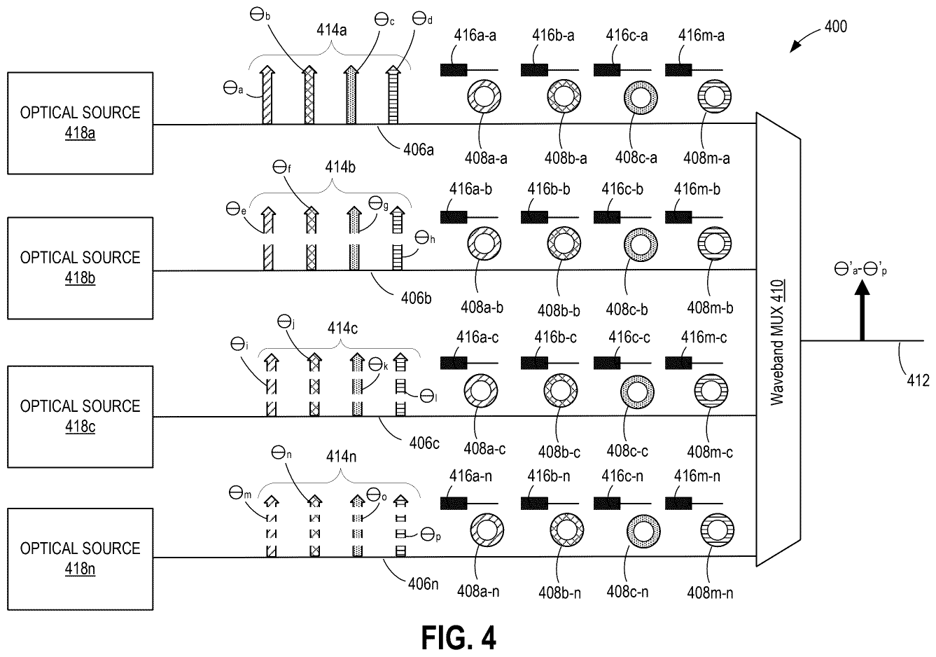

FIG. 4 depicts another example optical transmitter 400, in accordance with various examples of the presently disclosed technology. Optical transmitter 400 may be an example implementation of the transmitter system 110 of FIG. 1. Optical transmitter 400 includes a plurality of input waveband waveguides 406a-406n, a plurality of optical modulators 408a-a through 408n-m, waveband MUX 410, and output waveguide 412.

Optical transmitter 400 may be similar to optical transmitter 300 as described above, except that the optical transmitter 400 may receive a plurality of optical signals comprising one or more wavebands from a plurality of optical sources 418a-418n. In this case, each optical source 418a-418n may generate a respective waveband comprising a range of wavelengths and supply the respective waveband to a respective input waveband waveguide 406a-406n. For example, optical source 418a may generate waveband 414a, comprising optical signals ⊖ₐ-⊖_{d}, and supply the waveband 414a to waveband waveguide 406a. Similarly, optical source 418b may generate waveband 414b, comprising optical signals ⊖ₑ-⊖ₕ, and supply the waveband 414b to waveband waveguide 406b; optical source 418c may generate waveband 414c, comprising optical signals ⊖ᵢ-⊖ₗ, and supply the waveband 414c to waveband waveguide 406c; and optical source 418n may generate waveband 414n, comprising optical signals ⊖ₘ-⊖ₚ, and supply the waveband 414n to waveband waveguide 406n. Optical sources 414a-418n may be example implementations of dedicated optical source 118 of FIG. 1 (e.g., individual comb lasers dedicated to each waveband waveguide 406a-406n).

Since the wavebands are split amongst the waveband waveguides 406a-406n, optical transmitter 400 does not need a waveband DEMUX. Instead, the input waveband waveguides 406a-406n may carry the optical signals to respective optical modulators 408a-a through 408m-n directly. Removing the waveband DEMUX may improve power consumption and loss budget as compared to optical transmitter 300.

As alluded to above, optical transmitter 400 may be similar to optical transmitter 300. Accordingly, optical modulators 408 a-a through 408m-n may impart separate packets of data onto optical signals ⊖ₐ-⊖ₚ, respectively, in a manner substantially similar to that described above in connection with FIG. 3. These modulated optical signals may be represented as optical signals ⊖′ₐ-⊖′ₚ, respectively. Optical modulators optical modulators 408a-a through 408m-n may be substantially similar to optical modulators 308a-a through 308m-n and may be implemented as MRRs, as described above. As such, the wavebands 414a-414n and wavelengths of optical signals ⊖ₐ-⊖ₚ may be dependent upon the FSR of the MRRs, as described above in connection with FIG. 3. Optical transmitter 400 also includes monitor photodetectors 416a-a through 416m-n, which may be substantially similar to monitor photodetectors 316a-a through 316m-n.

Modulated optical signals ⊖′ₐ-⊖′ₚ may be carried to waveband MUX 410, which may be substantially similar to waveband MUX 310 of FIG. 3. Accordingly, as described above, waveband MUX 310 may combine the modulated optical signals of the four wavebands onto a single output waveguide 412. As will be described below, these modulated optical signals may be an example of the modulated optical signal OPT_{MOD} of FIG. 1, which can be carried to an optical receiver (e.g., receiver system 120 of FIG. 1). The optical receiver can operate to detect and decode the modulated optical signals.

The example of FIG. 4 may facilitate widening of wavebands and/or guard bands as compared to the wavebands utilized by the optical transmitter 300 of FIG. 3. The space between wavebands 414a-414n may be wider than the FSR of the optical modulators 416a-a through 416m-n. This can allow a wider passband and improve crosstalk between adjacent wavebands. The wider passband can provide wider tolerances on a central wavelength of the optical sources 414a-414n (e.g., wider comb lasers central wavelength).

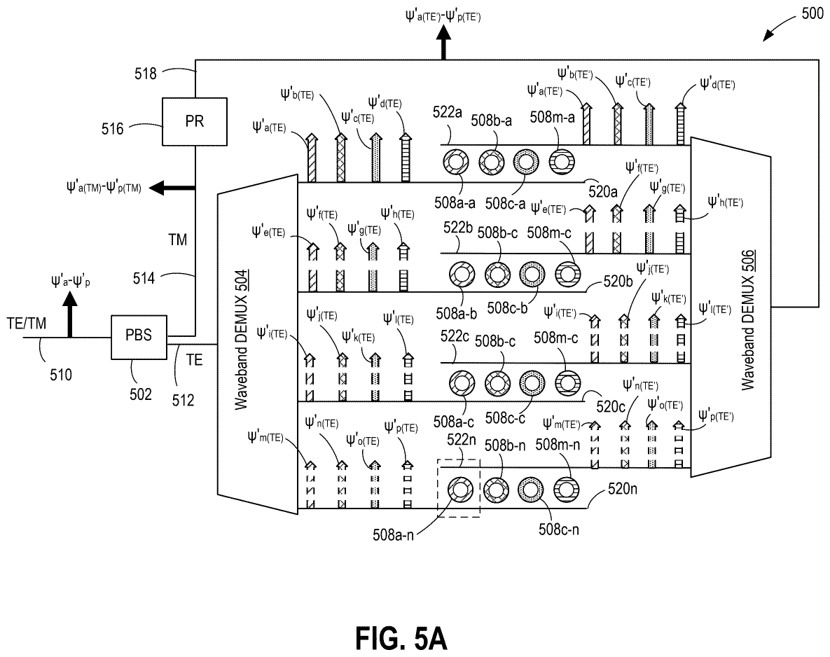

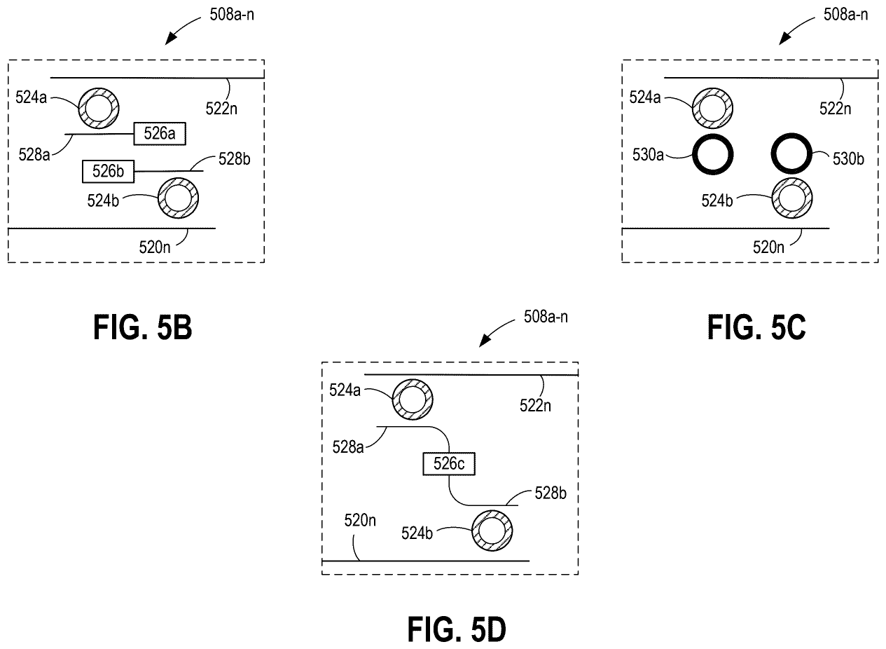

FIG. 5A depicts an example optical receiver 500, in accordance with various examples of the presently disclosed technology. Optical receiver 500 may be an example implementation of the receiver system 120 of FIG. 1. Optical receiver 500 may be comprised of a polarization beam splitter (PBS) 502, a polarization rotator (PR) 516, waveband DEMUXs 504 and 506, and optical detectors 508a-a through 508m-n, and various waveguides that connect the aforementioned components.

In examples, an optical receiver may detect modulated optical signals of one or more wavebands received from an input waveguide. These wavebands may be comprised of two or more wavelengths. For example, the wavebands may be received according to the waveband architecture 200 described above in connection with FIG. 2.

As described above, by detecting modulated optical signals, an optical receiver may read/extract the data imparted onto the modulated optical signals. In the example of FIG. 5A, optical receiver 500 may receive 16 modulated optical signals of 16 different wavelengths on a single input waveguide 510 (i.e., optical signals ψ′ₐ-ψ′ₚ). These 16 different wavelengths may comprise four wavebands of four wavelengths each. For example, the wavelengths of optical signals ψ′ₐ-ψ′_{d} may comprise a first waveband; the wavelengths of optical signals ψ′ₑ-ψ′ₕ may comprise a second waveband; the wavelengths of optical signals ψ′ᵢ-ψ′ₗ may comprise a third waveband; and the wavelengths of optical signals ψ′ₘ-ψ′ₚ may comprise a fourth waveband. In examples, optical receiver 500 may receive modulated optical signals of a different number of wavebands (e.g., optical signals of two wavebands, three wavebands, five wavebands, etc.). Similarly, the wavebands may be comprised of additional wavelengths (e.g., three wavelengths per waveband, five wavelengths per waveband, etc.).

In the specific example of FIG. 5A, optical receiver 500 receives optical signals of four wavebands, where each waveband is comprised of four wavelengths. Said differently, optical receiver 500 may receive 16 optical signals on a single input waveguide 510. Accordingly, optical receiver 500 may operate with any optical transmitters described in conjunction with FIGS. 1, 3 and 4. As a reminder from above, these optical transmitters can modulate optical signals of these 16 wavelengths. In examples, the light beam comprising optical signals ψ′ₐ-ψ′ₚ (e.g., an aggregate optical signal) may be an example of optical signal OPT_{MOD} on optical transmission medium 130 (e.g., as input waveguide 510) and the individual optical signals ψ′ₐ-ψ′ₚ may be examples of discrete optical signals propagating at a respective wavelength.

In various examples, optical receiver 500 may implement a polarization diversity scheme.

Polarization is a property of electromagnetic waves that specifies the geometrical orientation of the primary electric field component of the electromagnetic waves. An electromagnetic wave, such as light, consists of a coupled oscillating electric field and an oscillating magnetic field that are perpendicular to each other. In general, when light travels in an optical fiber/waveguide, the polarization of the light is allowed to rotate. Thus, by the time optical receiver 500 receives modulated optical signals ψ′ₐ-ψ′ₚ, the modulated optical signals will typically have an unknown polarization. Said differently, the orientation of the oscillating electric and magnetic fields of these optical signals may be unknown.

In general, the response of optical receivers is polarization dependent. In other words, an optical receiver may have a higher response to one polarization over another. Also, optical waveguides are typically polarization dependent, and photonic integrated circuits are easier to design for a single polarization. Accordingly, many photonic integrated circuits, especially those found in silicon foundry PDKs, are polarization dependent, and the optical elements built from these waveguides are optimized for a single polarization. In most cases, they are optimized for the TE mode.

Accordingly, waveguide 510 may have polarization dependence. Said differently, waveguide 510 may have two modes. The first mode may be a transverse-electric (TE) mode. The oscillating electromagnetic fields of modulated optical signals ψ′ₐ-ψ′ₚ may partially excite the TE mode. This TE mode may have a known polarization state (e.g., a “horizontal” polarization state). The second mode may be a transverse-magnetic (TM) mode. The oscillating electromagnetic fields of modulated optical signals ψ′ₐ-ψ′ₚ may partially excite the TM mode. This TM mode may have a known polarization state (e.g., a “vertical” polarization state). As part of optical receiver 500's polarization diversity scheme, these two modes may be split spatially onto two separate waveguides via PBS 502.

Accordingly, waveguide 510 may carry modulated optical signals ψ′ₐ-ψ′ₚ to PBS 502. A PBS may refer to an optical device that spatially splits a light beam (such as the light beam comprised of modulated optical signals ψ′ₐ-ψ′ₚ) into two physically separated light beams that have known polarization states that are orthogonal to each other. Accordingly, PBS 502 may split the light beam comprising modulated optical signals ψ′ₐ-ψ′ₚ into two separate light beams. The first light beam may comprise the TE mode of the input light beam (i.e., the “horizontal” polarization state), and may continue to propagate along waveguide 512 (which may only have the single TE mode). The second light beam may comprise the TM mode of the input light beam (i.e., the “vertical” polarization state), and may continue to propagate along waveguide 514 (which may only have the single TM mode). The modulated optical signals of this first light beam may be represented as modulated optical signals ψ′ₐ(TE)-ψ′ₚ(TE) (not shown). The modulated optical signals of the second light beam may be represented as optical signals ψ′ₐ(TM)-ψ′ₚ(TM), shown for illustrative purposes as a single aggregate signal.

In certain examples, waveguide 514 may carry modulated optical signals ψ′ₐ(TM)-ψ′ₚ(TM) to a polarization rotator 516. A polarization rotator may refer to an optical device that rotates the polarization state of a light beam. Accordingly, polarization rotator 516 may rotate the polarization state of modulated optical signals ψ′ₐ(TM)-ψ′ₚ(TM) 90 degrees so that they propagate in the TE mode as well. The rotated modulated optical signals may be represented as ψ′ₐ(TE′)-ψ′ₚ(TE′) (shown as a single aggregate signal for illustrative purposes), and may propagate along waveguide 518 in the TE mode. In other example, polarization rotator 516 may be removed such that modulated optical signals ψ′ₐ(TM)-ψ′ₚ(TM) may be carried by waveguide 518. In other example, the polarization PBS 502 and polarization rotator 516 functions may be incorporated in a polarization beamsplitter rotator.

After polarization beam splitting 516 (and in certain examples, polarization rotation), the modulated optical signals of known polarization may be carried to waveband DEMUXs. For example, waveguide 512 may carry modulated optical signals ψ′ₐ(TE)-ψ′ₚ(TE) to waveband DEMUX 504, and waveguide 518 may carry modulated optical signals (e.g., ψ′ₐ(TE′)-ψ′ₚ(TE′) or ψ′ₐ(TM)-ψ′ₚ(TM), depending on the implementation) to waveband DEMUX 506.

Waveband DEMUX 504 and 506 may be the same/similar as the waveband DEMUXs described in conjunction with previous figures. Accordingly, waveband DEMUX 504 may split modulated optical signals ψ′ₐ(TE)-ψ′ₚ(TE) by waveband (e.g., modulated optical signals ψ′ₐ(TE)-ψ′_{d}(TE) may be split onto a first waveband waveguide 520a; modulated optical signals ψ′ₑ(TE)-ψ′ₕ(TE) may be split onto a second waveband waveguide 520b; modulated optical signals ψ′ᵢ(TE)-ψ′ₗ(TE) may be split onto a third waveband waveguide 520c; modulated optical signals ψ′ₘ(TE)-ψ′ₚ(TE) may be split onto a fourth waveband waveguide 520n etc.). In the same/similar fashion, in the case of polarization rotator 516, waveband DEMUX 506 may split modulated optical signals ψ′ₐ(TE′)-ψ′ₚ(TE′) (or ψ′ₐ(TM)-ψ′ₚ(TM)) by waveband.

Waveband DEMUXs may split optical signals by waveband onto separate waveguides dedicate for specific wavebands. In examples, waveband DEMUX 504 may split modulated optical signals ψ′ₐ(TE)-ψ′ₚ(TE) into four wavebands onto waveband waveguides 520a-520n (sometimes collectively referred to as waveband waveguides 520). In the example of FIG. 5A, waveband DEMUX 504 may split optical signals ψ′ₐ(TE)-ψ′_{d}(TE) of a first waveband onto a waveband waveguide 520a; optical signals ψ′ₑ(TE)-ψ′ₕ(TE) of second waveband onto a waveband waveguide 520b; optical signals ψ′ᵢ(TE)-ψ′ₗ(TE) of third waveband onto a waveband waveguide 520c; and optical signals ψ′ₘ(TE)-ψ′ₚ(TE) of fourth waveband onto a waveband waveguide 520n. Similarly, waveband DEMUX 506 may split modulated optical signals ψ′ₐ(TE′)-ψ′ₚ(TE′) into four wavebands onto waveband waveguides 522a-522n (sometimes collectively referred to as waveband waveguides 522). In the example of FIG. 5A, waveband DEMUX 506 may split optical signals ψ′ₐ(TE′)-ψ′_{d}(TE′) of the first waveband onto a waveband waveguide 522a; optical signals ψ′ₑ(TE′)-ψ′ₕ(TE′) of the second waveband onto a waveband waveguide 522b; optical signals ψ′ᵢ(TE′)-ψ′ₗ(TE′) of third waveband onto a waveband waveguide 522c; and optical signals ψ′ₘ(TE′)-ψ′ₚ(TE′) of fourth waveband onto a waveband waveguide 522n.

These waveband waveguides 520a-520n and 522a-522n may carry the optical signals (sometimes referred to herein as post-demultiplexed optical signals) to optical detectors 508a-a through 508m-n. Optical detectors 508a-508m-n may detect modulated optical signals ψ′ₐ(TE)-ψ′ₚ(TE) and signals ψ′ₐ(TE′)-ψ′ₚ(TE′), which may correspond to reading/extracting the data imparted onto them. Adjacent to each of waveband waveguide 520a-520n and 522a-522n may be subset of optical detectors 508a-a through 508m-n. For example, optical detectors 508a-a through 508m-a may be coupled to waveband waveguides 520a and 522a and configured to detect modulated optical signals ψ′ₐ(TE)-ψ′_{d}(TE) and signals ψ′ₐ(TE′)-ψ′_{d}(TE′); optical detectors 508a-b through 508m-b may be coupled to waveband waveguides 520b and 522b and configured to detect modulated optical signals ψ′ₑ(TE)-ψ′ₕ(TE) and signals ψ′ₑ(TE′)-ψ′ₕ(TE′); optical detectors 508a-c through 508m-c may be coupled to waveband waveguides 520c and 522c and configured to detect modulated optical signals ψ′ᵢ(TE)-ψ′ₗ(TE) and signals ψ′ᵢ(TE′)-ψ′ₗ(TE′); and optical detectors 508a-n through 508m-n may be coupled to waveband waveguides 520n and 522n and configured to detect modulated optical signals ψ′ₘ(TE)-ψ′ₚ(TE) and signals ψ′ₘ(TE′)-ψ′ₚ(TE′).

In examples, the optical detectors 508 may comprise a plurality of MRRs coupled to one or more photodetectors, where one or more of the plurality of MRRs are coupled to waveband waveguide 522 and one or more of the plurality of MRRs are coupled to the waveband waveguide 520. In examples, the one or more MRRs of a respective optical detector couples respective pairs of waveband waveguides 522 and 520, and pairs of modulated signals (e.g. ψ′ₐ(TE) and ψ′ₐ(TE′)). Similar to the other components described above, these MRRs and photodetectors may be custom designed or constructed/sourced from readily available silicon photonic foundry process design kits.

FIGS. 5B-5D depict a few example implementations of optical detector 508a-n, which may be illustrative examples of optical detectors 508a-a through 508m-n. While certain implementations are shown in FIGS. 5B-5D, examples of the present disclosure are not limited to these implementations. Other implementations may be utilized to detect optical signals by optical detectors 508. Additionally, each optical detector 508 may be implemented using the same implementation or using different implementations. For example, optical detectors 508 may each be implemented using the example shown in FIG. 5B, FIG. 5C or FIG. 5D. In another example, a first subset of optical detectors 508 may be implemented using the example shown in FIG. 5B, while a second subset of optical detectors 508 may be implemented using the example shown in FIG. 5C. A third subset of optical detectors 508 may also be implemented using the example shown in FIG. 5D. Other combinations may be utilized as desired.

As shown in FIG. 5B, optical detector 508a-n includes a pair of MRRs 524a and 524b, each of which are optically coupled to a respective drop waveguide 528a and 528b. The drop waveguides 528a and 528b can be respectively connected to one of photodetectors 526a and 526b. In this example, MRR 524a is optically coupled to waveband waveguide 522n and MRR 524b is optically coupled to waveband waveguide 520n. The MRR 524a couples to waveband waveguide 522n and modulated signals ψ′ₘ(TE). The drop waveguide 528a receives modulated signals ψ′ₘ(TE) from MRR 524a and the modulated signals ψ′ₘ(TE) is detected by photodetector 526a. Likewise, the MRR 524b couples to waveband waveguide 520n and modulated signals ψ′ₘ(TE′) and the modulated signals ψ′ₘ(TE) is detected by photodetector 526a.

As shown in FIG. 5C, optical detector 508a-n includes a pair of MRRs 524a and 524b, each of which are comprise a photodetector incorporated therein. In this example, MRR 524a is optically coupled to MRR 530a and MRR 524b is optically coupled to MRR 524b. The MRR 524a couples to modulated signals ψ′ₘ(TE′), which is coupled into MRR 530a and detected by the photodetector incorporated therein. Likewise, the MRR 524b couples to couples to modulated signals ψ′ₘ(TE), which is coupled into MRR 530b and detected by the photodetector incorporated therein.

As shown in FIG. 5D, optical detector 508a-n includes a pair of MRRs 524a and 524b, each of which are optically coupled to a respective drop waveguide 528a and 528b. The drop waveguides 528a and 528b can be connected to a photodetector 526c. In this example, MRR 524a is optically coupled to waveband waveguide 522n and MRR 524b is optically coupled to waveband waveguide 520n. The MRR 524a couples to waveband waveguide 522n and modulated signals ψ′ₘ(TE′). The drop waveguide 528a receives modulated signals ψ′ₘ(TE′), which is detected by photodetector 526c. Likewise, the MRR 524b couples to waveband waveguide 520n and modulated signals ψ′ₘ(TE), which is detected by photodetector 526c.

Returning to FIG. 5A, in the example of optical receiver 500 the optical detectors 508a-a through 508m-n (sometimes collectively referred to herein as optical detectors 508 or individually as optical detector 508) act as drop filters for optical signals of certain wavelengths. For example, an MRR of a respective optical detector 508 may be tuned to “drop” modulated optical signals of a wavelength of a waveband carried on a respectively coupled waveband waveguide 520/522, while allowing modulated optical signals of other wavelengths to pass undisturbed. Accordingly, as an example, an MRR of optical detector 508a-a may drop modulated optical signals ψ′ₐ(TE) and ψ′ₐ(TE′) onto a respective drop waveguide that includes a respective photodetector—while allowing modulated optical signals ψ′_{b}(TE)-ψ′_{d}(TE) and ψ′_{b}(TE′)-ψ′_{d}(TE′) to pass undisturbed. In the same/similar manner, optical detector 508m-a may drop modulated optical signals ψ′_{d}(TE) and ψ′_{d}(TE′) onto a respective drop waveguide that includes a respective photodetector—while allowing modulated optical signals ψ′ₐ(TE)-ψ′_{c}(TE) and ψ′ₐ(TE′)-ψ′_{c}(TE′) to pass undisturbed. MRRs of the optical detectors 508 may be tuned in the same/similar manner such that they “drop” modulated optical signals of one wavelength per waveband while allowing modulated optical signals of other wavelengths to pass undisturbed.

As described above, MRRs may be tuned to drop optical signals of a certain wavelength. This certain wavelength may be an initial resonance wavelength. As such, as detailed above, the MRRs of optical detectors 508 may be also resonant at a plurality of resonance mode wavelengths separated by a respective FSR. Thus, the MRRs may be tuned to modulate an initial resonance wavelength and respective resonance modes, while allowing optical signals of different wavelengths to pass undisturbed. The aggregate optical signal (e.g., ψ′ₐ(TE)-ψ′ₚ(TE) and signals ψ′ₐ(TE′)-ψ′ₚ(TE′)—or ψ′ₐ(TM)-ψ′ₚ(TM)-as a single optical signal) may be based on the number of MRRs implemented in the optical receiver 500 and the FSRs of one or more of the optical detectors 508.

For example, as described above, modulated optical signals ψ′ₐ(TE)-ψ′ₚ(TE) and ψ′ₐ(TE′)-ψ′ₚ(TE′) (or ψ′ₐ(TM)-ψ′ₚ(TM)) may be grouped into distinct wavebands. The spectral width of the wavebands can be configured according to the FSR of at least one optical detector 508 (e.g., at least on MRR of the optical detectors 508). That is, as described above in connection with FIGS. 1-4, the wavebands may be separated by the FSR or the separation may be larger than the FSR, such that the ranges of wavelengths of modulated optical signals ψ′ₐ(TE)-ψ′ₚ(TE) and ψ′ₐ(TE′)-ψ′ₚ(TE′) (or ψ′ₐ(TM)-ψ′ₚ(TM)) that are included in each waveband comprise a discrete optical signal of each detector. For example, as described above, the first waveband may comprise modulated optical signals ψ′ₐ(TE)-ψ′_{d}(TE) and ψ′ₐ(TE′)-ψ′_{d}(TE′) (or ψ′ₐ(TM)-ψ′_{d}(TM)), the second waveband may comprise modulated optical signals ψ′ₑ(TE)-ψ′ₕ(TE) and ψ′ₑ(TE′)-ψ′ₕ(TE′) (or ψ′ₑ(TM)-ψ′ₕ(TM)); the third waveband may comprise modulated optical signals ψ′ᵢ(TE)-ψ′ₗ(TE) and ψ′ᵢ(TE′)-ψ′ₗ(TE′) (or ψ′ᵢ(TM)-ψ′ₗ(TM)); and the fourth waveband may comprise modulated optical signals ψ′ₘ(TE)-ψ′ₚ(TE) and ψ′ₘ(TE′)-ψ′ₚ(TE′) (or ψ′ₘ(TM)-ψ′ₚ(TM)). Modulated optical signal ψ′ₐ(TE′) and ψ′ₐ(TE) may be propagating at the initial resonance wavelength of optical detector 508a-a and modulated optical signals ψ′ₑ(TE), ψ′ᵢ(TE), ψ′ₘ(TE), ψ′ₑ(TE′), ψ′ᵢ(TE′), and ψ′ₘ(TE′) may be propagating at resonance mode wavelengths of detector 508a-a. Similarly, modulated optical signal ψ′_{b}(TE′) and ψ′_{b}(TE) may be propagating at the initial resonance wavelength of optical detector 508b-a and modulated optical signals ψ′_{f}(TE), ψ′ⱼ(TE), ψ′ₙ(TE), ψ′_{f}(TE′), ψ′ⱼ(TE′), and ψ′ₙ(TE′) may be propagating at the resonance mode wavelengths of optical detector 508b-a; modulated optical signal ψ′_{c}(TE′) and ψ′_{c}(TE) may be propagating at the initial resonance wavelength of optical detector 508c-a and modulated optical signals ψ′_{g}(TE), ψ′ₖ(TE), ψ′ₒ(TE), ψ′_{g}(TE′), ψ′ₖ(TE′), and ψ′ₒ(TE′) may be propagating at the resonance mode wavelengths of optical detector 508c-a; and modulated optical signal ψ′_{d}(TE′) and ψ′_{d}(TE) may be propagating at the initial resonance wavelength of optical detector 508m-a and modulated optical signals ψ′ₕ(TE), ψ′ₗ(TE), ψ′ₚ(TE), ψ′ₕ(TE′), ψ′ₗ(TE′), and ψ′ₚ(TE′) may be propagating at the resonance mode wavelengths of optical detector 508m-a.

The initial resonance wavelength and the FSR of an optical detector 508 may be defined by a round-trip length of an MRR of the detector. Accordingly, in some examples, the subsets of optical detectors 508 may have MRRs having common round-trip lengths and construction (e.g., materials and operating parameters). In this case, the MRRs of a given subset may share a common initial resonance wavelength and common resonance mode wavelengths. In a particular examples, a first subset of optical detectors 508a-a through 508a-n may comprise MRRs tuned to receive at wavelengths of modulated optical signal ψ′ₐ(TE′) and ψ′ₐ(TE) as the initial resonance wavelength and wavelengths of modulated optical signals ψ′ₑ(TE), ψ′ᵢ(TE), ψ′ₘ(TE), ψ′ₑ(TE′), ψ′ᵢ(TE′), and ψ′ₘ(TE′) as resonance mode wavelengths. As such, optical detectors 508a-b, 508a-c, and 508a-n may be instances of optical detector 508a-a. Similarly, optical detectors 508b-b, 508b-c, and 508b-n may be instances of optical detector 508b-a; optical detectors 508c-b, 508c-c, and 508c-n may be instances of optical detector 508c-a; and optical detectors 508m-b, 508m-c, and 508m-n may be instances of optical detector 508m-a.

The example of FIG. 5 illustrates an implementation in which four wavebands are detected. However, as noted above, optical receiver 500 may receive optical signals of a different number of wavebands (e.g., optical signals of two wavebands, three wavebands, five wavebands, etc.). To accommodate more or fewer wavebands, optical receiver 500 can be configured with more or fewer waveguides between following waveband DEMUXs 506 and/or 504. For example, since the example of FIG. 5 is described in connection with four wavebands, four waveband waveguides 520 and four waveband waveguides 522 are shown. To add additional wavebands, additional instances of waveband waveguides 520 and 522 can be added, each optically coupled to additional detectors configured to receive wavelengths of optical signals contained within the additional wavebands.

Similarly, the example of FIG. 5 illustrates an implementation in which each waveband comprises four wavelengths. However, as noted above, each waveband may comprise a different number of wavelengths. To accommodate more or fewer wavelengths, additional or fewer optical detectors 508 can be coupled to waveband waveguides 520 and 522 depending on the number of wavelengths. For example, since the example of FIG. 5 is described in connection with four wavelengths, four optical detectors 508 are shown coupled to respective waveband waveguides 520 and 522. To add additional wavelengths, additional detectors can be added, each tuned to modulate wavelengths of the additional optical signals.

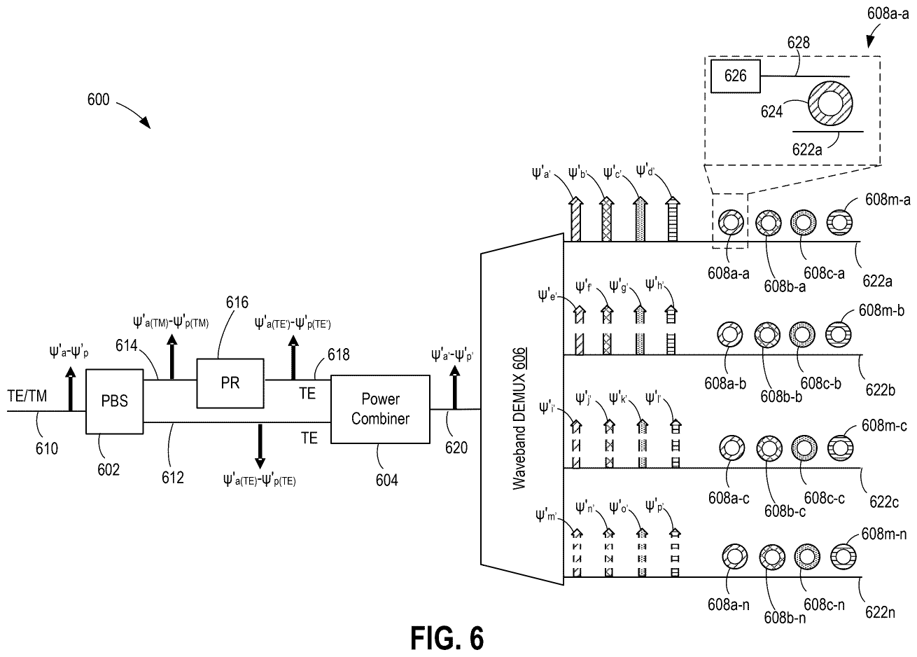

FIG. 6 depicts another example optical receiver 600, in accordance with various examples of the presently disclosed technology. Optical receiver 600 may be an example implementation of the receiver system 120 of FIG. 1. Optical receiver 600 may be comprised of a PBS 602, a PR 616, a power combiner 604, waveband DEMUX 606, and optical detectors 608a-a through 608m-n (collectively referred to herein as optical detectors 608 and individually as optical detector 608), and various waveguides which connect the aforementioned components. Optical receiver 600 may be substantially similar to optical receiver 500, except as provided herein.

In examples, optical receiver 600 may detect modulated optical signals of one or more wavebands received from an input waveguide. These wavebands may be comprised of two or more wavelengths. For example, the wavebands may be received according to the waveband architecture 200 described above in connection with FIG. 2.

As described above, by detecting modulated optical signals, an optical receiver may read/extract the data imparted onto the modulated optical signals. In the example of FIG. 6, optical receiver 600 may receive 16 modulated optical signals of 16 different wavelengths on a single input waveguide 610 (i.e., optical signals ψ′ₐ-ψ′ₚ). These 16 different wavelengths may comprise four wavebands of four wavelengths each. For example, the wavelengths of optical signals ψ′ₐ-ψ′_{d} may comprise a first waveband; the wavelengths of optical signals ψ′ₑ-ψ′ₕ may comprise a second waveband; the wavelengths of optical signals ψ′ᵢ-ψ′ₗ may comprise a third waveband; and the wavelengths of optical signals ψ′ₘ-ψ′ₚ may comprise a fourth waveband. In examples, optical receiver 600 may receive modulated optical signals of a different number of wavebands (e.g., optical signals of two wavebands, three wavebands, five wavebands, etc.). Similarly, the wavebands may be comprised of additional wavelengths (e.g., three wavelengths per waveband, five wavelengths per waveband, etc.).

In the specific example of FIG. 6, optical receiver 600 receives optical signals of four wavebands, where each waveband is comprised of four wavelengths. Said differently, optical receiver 600 may receive 16 optical signals on a single input waveguide 610. Accordingly, optical receiver 600 may operate with any optical transmitters described in conjunction with FIGS. 1, 3 and 4. As a reminder from above, these optical transmitters can modulate optical signals of these 16 wavelengths. In examples, the light beam comprising optical signals ψ′ₐ-ψ′ₚ (e.g., an aggregate optical signal) may be an example of optical signal OPT_{MOD} on optical transmission medium 130 (e.g., as input waveguide 610) and the individual optical signals ψ′ₐ-ψ′ₚmay be examples of discrete optical signals propagating at a respective wavelength.

In various examples, optical receiver 600 may implement a polarization diversity scheme. Waveguide 610 may have polarization dependence. A first mode may be a TE mode. The oscillating electromagnetic fields of modulated optical signals ψ′ₐ-ψ′ₚ may partially excite the TE mode. A second mode may be a transverse-magnetic (TM) mode. The oscillating electromagnetic fields of modulated optical signals ψ′ₐ-ψ′ₚ may partially excite the TM mode. As part of optical receiver 600's polarization diversity scheme, these two modes may be split spatially onto two separate waveguides via PBS 602.

Accordingly, waveguide 610 may carry modulated optical signals ψ′ₐ-ψ′ₚ to PBS 602. PBS 602 may split the light beam comprising modulated optical signals ψ′ₐ-ψ′ₚ into two separate light beams. The first light beam may comprise the TE mode of the input light beam and may continue to propagate along waveguide 612. The second light beam may comprise the TM mode of the input light beam and may continue to propagate along waveguide 614. The modulated optical signals of this first light beam may be represented as modulated optical signals ψ′ₐ(TE)-ψ′ₚ(TE), shown for illustrative purposes as a single aggregate signal. The modulated optical signals of the second light beam may be represented as optical signals ψ′ₐ(TM)-ψ′ₚ(TM), shown for illustrative purposes as a single aggregate signal.

In certain examples, waveguide 614 may carry modulated optical signals ψ′ₐ(TM)-ψ′ₚ(TM) to a polarization rotator 616. Polarization rotator 616 may rotate the polarization state of modulated optical signals ψ′ₐ(TM)-ψ′ₚ(TM) 90 degrees so that they propagate in the TE mode as well. The rotated modulated optical signals may be represented as ψ′ₐ(TE′)-ψ′ₚ(TE′) (shown as a single aggregate signal for illustrative purposes), and may propagate along waveguide 618 in the TE mode.

After polarization beam splitter 602 and polarization rotator 616, the modulated optical signals of known polarization may be carried to a power combiner 604. A power combiner may refer to an optical device tuned to coherently combine optical power from multiple inputs onto a single waveguide. Accordingly, power combiner 604 may combine the modulated optical signals ψ′ₐ(TE)-ψ′ₚ(TE) and modulated optical signals ψ′ₐ(TE′)-ψ′ₚ(TE′) into a single modulated optical signals ψ′_{a′}-ψ′_{p′} that are output onto waveguide 620.

After power combiner 604, the combined modulated optical signals of known polarization may be carried to waveband DEMUX 606. For example, waveguide 620 may carry modulated optical signals ψ′_{a′}-ψ′_{p′} to waveband DEMUX 606. Waveband DEMUX 606 may be the same/similar as the waveband DEMUXs described in conjunction with previous figures. Accordingly, waveband DEMUX 606 may split modulated optical signals ψ′_{a′}-ψ′_{p′} by waveband (e.g., modulated optical signals ψ′_{a′}-ψ′_{d′} may be split onto a first waveband onto a first waveband waveguide 622a; modulated optical signals ψ′_{e′}-ψ′_{h′} may be split onto a second waveband onto a second waveband waveguide 622b; modulated optical signals ψ′_{i′}-ψ′_{l′} may be split onto a third waveband onto a third waveband waveguide 622c; modulated optical signals ψ′_{m′}-ψ′_{p′} may be split onto a fourth waveband onto a fourth waveband waveguide 622n etc.).

These waveband waveguides 622a-622n may carry the optical signals (sometimes referred to herein as post-demultiplexed optical signals) to optical detectors 608. Optical detectors 608 may detect modulated optical signals ψ′_{a′}-ψ′_{p′}, which may correspond to reading/extracting the data imparted onto them. Adjacent to each of waveband waveguide 622 may be subset of optical detectors 608. For example, optical detectors 608a-a through 608m-a may be coupled to waveband waveguide 622a and configured to detect modulated optical signals ψ′_{a′}-ψ′_{d′}; optical detectors 608a-b through 608m-b may be coupled to waveband waveguide 622b and configured to detect modulated optical signals ψ′_{e′}-ψ′_{h′}; optical detectors 608a-c through 608m-c may be coupled to waveband waveguide 622c and configured to detect modulated optical signals ψ′_{i′}-ψ′_{l′}; and optical detectors 608a-n through 608m-n may be coupled to waveband waveguide 622n and configured to detect modulated optical signals ψ′_{m′}-ψ′_{p′}.

In examples, the optical detectors 608 may be substantially similar to optical detectors 508 of FIG. 5. For example, optical detectors 608 may comprises a MRR, a drop waveguide, and a photodetector. A zoomed in portion of optical detector 608a-a is shown in FIG. 6 as an illustrative example of optical detectors 608. As shown in FIG. 6, optical detector 608a-a includes an MRR 624 optically coupled to a drop waveguide 628 connected to photodetector 626. The MRR 624 is optically coupled to waveband waveguides 622a.

As described above in connection with FIG. 5B, as an example of optical detectors 608, the MRR 624 of optical detector 608a-a couples waveband waveguides 622a to the waveguide 628 that carries coupled signals to photodetectors 626. Similarly, the MRR of a respective optical detector 608 couples a respective waveband waveguide 622 to a respective drop waveguide 628 that carries coupled signals to a respective photodetector 626. Similar to the other components described above, these microring resonators may be constructed/sourced from readily available silicon photonic foundry process design kits. In another example, the photodetector 626 and waveguide 628 may be replaced with a MRR similar to MRR 530a or 530b of FIG. 5C.

In the example of optical receiver 600, the optical detectors 608 act as drop filters for optical signals of certain wavelengths. For example, an MRR of a respective optical detector 608 may be tuned to “drop” modulated optical signals of a wavelength of a waveband carried on a respectively coupled waveband waveguide 622, while allowing modulated optical signals of other wavelengths to pass undisturbed. Accordingly, as an example, an MRR of optical detector 608a-a may drop modulated optical signals ψ′_{a′} onto a respective drop waveguide 628 that includes a respective photodetector 626—while allowing modulated optical signals ψ′_{b}-ψ′_{d} to pass undisturbed. MRRs of the optical detectors 608 may be tuned in the same/similar manner such that they “drop” modulated optical signals of one wavelength per waveband while allowing modulated optical signals of other wavelengths to pass undisturbed.

As described above, MRRs may be tuned to receive optical signals of a certain wavelength. This certain wavelength may be an initial resonance wavelength. As such, as detailed above, the MRRs of optical detectors 608 may be also resonant at a plurality of resonance mode wavelengths separated by a respective FSR. Thus, the MRRs may be tuned to receive an initial resonance wavelength and respective resonance modes, while allowing optical signals of different wavelengths to pass undisturbed. The aggregate optical signal (e.g., ψ′_{a′}-ψ′_{p′} as a single optical signal) may be based on the number of MRRs implemented in the receiver 600 and the FSRs of one or more of the optical detectors 608.

For example, as described above, modulated optical signals ψ′_{a′}-ψ′_{p′} may be grouped into distinct wavebands. The spectral width of the wavebands can be configured according to the FSR of at least one optical detector 608 (e.g., at least one MRR of the optical detectors 608). That is, as described above in connection with FIGS. 1-5, the wavebands may be separated by the FSR or greater than the FSR, such that the ranges of wavelengths of modulated optical signals ψ′_{a′}-ψ′_{p′} that are included in each waveband comprise a discrete optical signal of each detector. For example, as described above, the first waveband may comprise modulated optical signals ψ′_{a′}-ψ′_{d′}, the second waveband may comprise modulated optical signals ψ′_{e′}-ψ′_{h′}; the third waveband may comprise modulated optical signals ψ′_{i′}-ψ′_{l′}; and the fourth waveband may comprise modulated optical signals ψ′_{m′}-ψ′_{p′}. Modulated optical signal ψ′_{a′} may be propagating at the initial resonance wavelength of optical detector 608a-a and modulated optical signals ψ′_{e′}, ψ′_{i′}, and ψ′_{m′} may be propagating at a resonance mode wavelength of optical detector 608a-a. Similarly, modulated optical signal ψ′_{b′} may be propagating at the initial resonance wavelength of optical detector 608b-a and modulated optical signals ψ′_{f′}, ψ′_{j′}, and ψ′_{n′} may be propagating at a resonance mode wavelength of optical detector 608b-a; modulated optical signal ψ′_{c′} may be propagating at the initial resonance wavelength of optical detector 608c-a and modulated optical signals ψ′_{g′}, ψ′_{k′}, and ψ′_{o′} may be propagating at the resonance mode wavelengths of optical detector 608c-a; and modulated optical signal ψ′_{d′} may be propagating at the initial resonance wavelength of optical detector 608m-a and modulated optical signals ψ′_{h′}, ψ′_{l′}, and ψ′_{p′} may be propagating at the resonance mode wavelengths of optical detector 608m-a.

As described above, the initial resonance wavelength and the FSR of an optical detector 608 may be defined by a round-trip length of an MRR of the detector. Accordingly, in some examples, the subsets of optical detectors 608 may have MRRs having common round-trip lengths and construction (e.g., materials and operating parameters). In this case, the MRRs of a given subset may share a common initial resonance wavelength and common resonance mode wavelengths. In a particular example, a first subset of optical detectors 608a-a through 608a-n may comprise MRRs tuned to modulate at wavelengths of modulated optical signal ψ′_{a′} as the initial resonance wavelength and wavelengths of modulated optical signals ψ′_{e′}, ψ′_{i′}, and ψ′_{m′} as resonance mode wavelengths. As such, optical detectors 608a-b, 608a-c, and 608a-n may be instances of optical detector 608a-a. Similarly, optical detectors 608b-b, 608b-c, and 608b-n may be instances of optical detector 608b-a; optical detectors 608c-b, 608c-c, and 608c-n may be instances of optical detector 608c-a; and optical detectors 608m-b, 608m-c, and 608m-n may be instances of optical detector 608m-a.

Through the use of the power combiner 604, example of FIG. 6 may provide for reduced power consumption and freedom of design and layout of the design. For example, by using the power combiner 604, the number of waveband DEMUX can be halved, as compared to optical receiver 500. As a result, the power consumption is likewise reduced by the removal of the waveband DEMUX and on chip real-estate is gained, providing design flexibility.

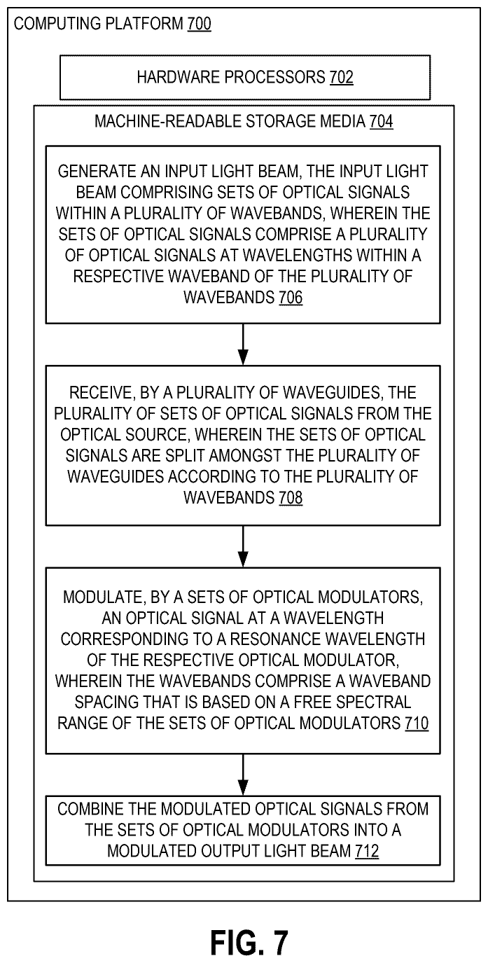

FIG. 7 illustrates a computing component that may be used to implement optical communications in accordance with various examples of the disclosed technology. Referring now to FIG. 7, computing component 700 may be, for example, a server computer, a controller, a switch or any other similar computing component capable of processing data. In the example implementation of FIG. 7, the computing component 700 includes a hardware processor 702 and machine-readable storage medium for 704.

Hardware processor 702 may be one or more central processing units (CPUs), semiconductor-based microprocessors, application specific integrated circuit, and/or other hardware devices suitable for retrieval and execution of instructions stored in machine-readable storage medium 704. Hardware processor 702 may fetch, decode, and execute instructions, such as instructions 706-712, to control processes or operations disclosed herein. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-712.

Hardware processor 702 may execute instruction 706 to generate an input light beam. The input light beam may comprise sets of optical signals within a plurality of wavebands and the sets of optical signals may comprise a plurality of optical signals at distinct wavelengths within a respective waveband of the plurality of wavebands. In examples, the light beam may be provided in accordance with waveband architecture 200 described in connection with FIG. 2. The light may be generated by one or more optical sources (e.g., optical source(s) 118 of FIG. 1 and/or optical sources 418a-418n of FIG. 4.)

Hardware processor 702 may execute instruction 708 to receive, by a plurality of waveguides, the sets of optical signals from the optical source. The sets of optical signals may be split amongst the plurality of waveguides according to the plurality of wavebands. For example, a demultiplexer, such as waveband DEMUX 304, may be provided that splits the input light beam into a plurality of post-demultiplexed light beams. In this case, each of the plurality of post-demultiplexed light beams comprises a set of optical signals of the sets of optical signals. In examples, the waveguides may be waveband waveguides 306a-306n and/or 406a-406n described in connection with FIGS. 3 and 4.

Hardware processor 702 may execute instruction 710 to modulate, by sets of optical modulators, an optical signal at a distinct wavelength corresponding to a resonance wavelength of the respective optical modulator. The plurality of wavebands may comprise a waveband spacing that is based on a free spectral range of the sets of optical modulators. In some examples, the waveband spacing can be equal to or greater than a free spectral range of an optical modulator of the sets of optical modulators. In another example, wherein the optical modulator has a shortest free spectral range from among the sets of optical modulators. In examples, each optical modulator modulates a respective optical signal at a first data rate, for example, the first data rate may be less than 100 Gbps, less than or equal to 65 Gbps, and less than or equal to 50 Gbps.

In various examples, the sets of optical modulators comprises a plurality of microring resonators (MRRs). In this case, a respective waveband of the plurality of wavebands comprise one resonance mode wavelength of each of the plurality of MRRs. For example, a first waveband may include initial resonance wavelengths of each of the plurality of MRRs, a second waveband may include first resonance wavelengths of each of the plurality of MRRs, a third waveband may include second resonance wavelengths of each of the plurality of MRRs, and so on.

Hardware processor 702 may execute instruction 712 to combine the modulated optical signals from the sets of optical modulators into a modulated output light beam. For example, a multiplexer may be provided that receives modulated optical signals from the sets of optical modulators and combines the discrete modulated optical into an aggregate optical signal that is provided to an output waveguide. In examples, the multiplexer may be waveband MUX 310 and/or waveband MUX 410 described in connection with FIGS. 3 and 4.

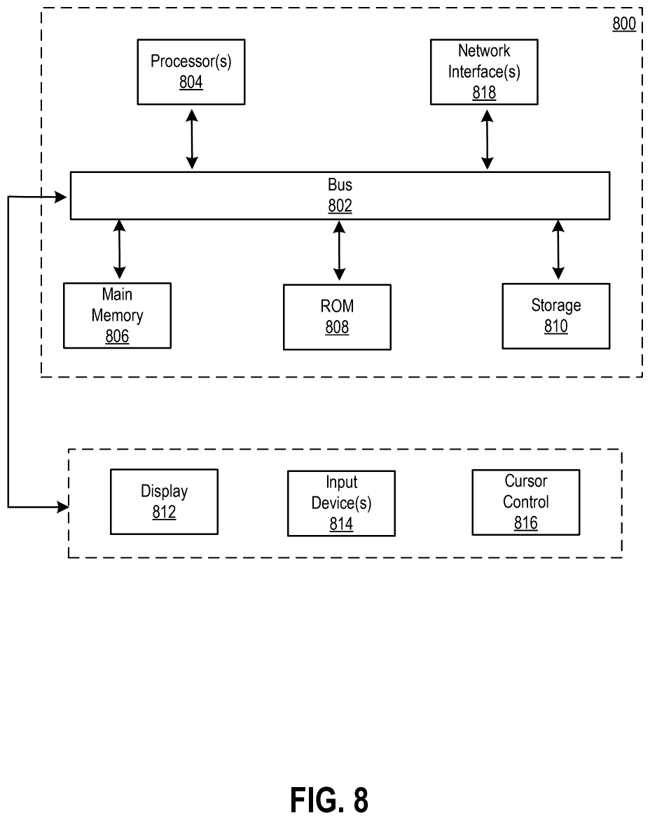

FIG. 8 depicts a block diagram of an example computer system 800 in which various examples of the disclosed technology described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors. The computer system 800 may be implemented to drive one or more components of the optical communication system 100 described in connection with FIG. 1; the optical transmitters 300 and/or 400 described in connection with FIGS. 3 and 4; and/or the optical receivers 500 and/or 600 described in connection with FIGS. 5A-6. For example, computer system 800 may be configured to cause optical sources to emit an optical signal, to drive tuning systems to tune modulation/demodulation systems, and/or decode data from optical signals detected by photodetectors.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions. For example, main memory 806 may store instructions, that when executed by processor(s) 804, cause computer system 800 to perform one or more of the operations described in connection with FIG. 7.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some examples, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” “data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one example of the disclosed technology, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes a network interface 818 (also referred to as a communication interface) coupled to bus 802. Network interface 818 provides a two-way data communication coupling to one or more network links that are connected to one or more local networks. For example, network interface 818 may be an integrated services digital network (ISDN) card, cable modem, satellite modem, or a modem to provide a data communication connection to a corresponding type of telephone line. As another example, network interface 818 may be a local area network (LAN) card to provide a data communication connection to a compatible LAN (or WAN component to communicated with a WAN). Wireless links may also be implemented. In any such implementation, network interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 818, which carry the digital data to and from computer system 800, are example forms of transmission media.

The computer system 800 can send messages and receive data, including program code, through the network(s), network link and network interface 818. In the Internet example, a server might transmit a requested code for an application program through the Internet, the ISP, the local network and the network interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An optical communication system comprising:
an optical source that generates an input light beam, the input light beam comprising sets of optical signals within a plurality of wavebands, wherein the sets of optical signals comprise a plurality of optical signals at wavelengths within respective wavebands of the plurality of wavebands;
a plurality of waveguides that receive the sets of optical signals from the optical source, wherein the sets of optical signals are split amongst the plurality of waveguides according to the plurality of wavebands;
sets of optical modulators optically coupled to the plurality of waveguides, wherein each optical modulator modulates an optical signal at a wavelength corresponding to a resonance wavelength of the respective optical modulator; and
a multiplexer that combines the modulated optical signals from the sets of optical modulators into a modulated output light beam,
wherein the plurality of wavebands comprise a waveband spacing that is based on a free spectral range of the sets of optical modulators.

2. The optical communication system of claim 1, wherein each optical modulator modulates a respective optical signal at a first data rate, wherein the first data rate is less than 100 Giga-bits per second.

3. The optical communication system of claim 1, wherein the waveband spacing is equal to or greater than a free spectral range of an optical modulator of the sets of optical modulators.

4. The optical communication system of claim 3, wherein the optical modulator has a shortest free spectral range from among the sets of optical modulators.

5. The optical communication system of claim 1, further comprising:
a demultiplexer that splits the input light beam into a plurality of post-demultiplexed light beams, wherein each of the plurality of post-demultiplexed light beams comprises a set of optical signals of the sets of optical signals.

6. The optical communication system of claim 5, wherein the optical source comprises at least one comb laser that emits the input light beam.

7. The optical communication system of claim 1, wherein the optical source comprises a plurality of comb lasers that emit the input light beam as a plurality of input light beams, each input light beam comprising a set of optical signals within a waveband of the plurality of wavebands.

8. The optical communication system of claim 1, wherein the sets of optical modulators comprise a plurality of microring resonators (MRRs), wherein a respective waveband of the plurality of wavebands comprise one resonance mode wavelength of each of the plurality of MRRs.

9. The optical communication system of claim 1, further comprising:
an optical transmitter comprising the optical source, the plurality of waveguides, the sets of optical modulators, and the multiplexer, wherein the optical transmitter imparts data onto the input light beam by modulating the optical signals, and wherein the optical source comprises a comb laser; and
an optical receiver that receivers the modulated optical signals and extracts the data from the modulated optical signals.

10. The optical communication system of claim 9, wherein the optical receiver comprises:
a demultiplexer that splits the modulated optical signals into a plurality of post-demultiplexed optical signals, wherein the modulated optical signal comprises sets of modulated discrete optical signals within the plurality of wavebands, wherein of each of the plurality of post-demultiplexed optical signals comprises a set of the modulated discrete optical signals of the sets of modulated discrete optical signals;
a plurality of receiver waveguides that receive the plurality of post-demultiplexed optical signals from the demultiplexer, wherein the sets of modulated optical signals are split amongst the plurality of receiver waveguides according to the plurality of wavebands; and
a sets of detectors optically coupled to the plurality of waveguides, wherein the sets of detectors comprise:
an optical detector that receives a post-demultiplexed optical signal via a waveguide of the plurality of waveguides and a drops the received post-demultiplexed optical signal at a wavelength corresponding to a resonance wavelength of the respective optical detector; and
a photodetector that detects the modulated post-demultiplexed optical signal from the optical detector to extract data imparted on the modulated optical signal.

11. A method comprising:
generating an input light beam, the input light beam comprising sets of optical signals within a plurality of wavebands, wherein the sets of optical signals comprise a plurality of optical signals at wavelengths within a respective waveband of the plurality of wavebands;
receiving, by a plurality of waveguides, the sets of optical signals, wherein the sets of optical signals are split amongst the plurality of waveguides according to the plurality of wavebands;
modulating, by sets of optical modulators, an optical signal at a wavelength corresponding to a resonance wavelength of the respective optical modulator; and
combining the modulated optical signals from the sets of optical modulators into a modulated output light beam,
wherein the plurality of wavebands comprise a waveband spacing that is based on a free spectral range of the sets of optical modulators.

12. The method of claim 11, further comprising:
modulating, by the plurality of optical modulators, a respective optical signal at a first data rate that is less than 100 Giga-bits per second.

13. The method of claim 11, wherein the waveband spacing is equal to or greater than a free spectral range of an optical modulator of the sets of optical modulators.

14. The method of claim 13, wherein the optical modulator has a shortest free spectral range from among the sets of optical modulators.

15. The method of claim 11, further comprising:
splitting, by a demultiplexer, the input light beam into a plurality of post-demultiplexed light beams, wherein each of the plurality of post-demultiplexed light beams comprises a set of optical signals of the sets of optical signals.

16. The method of claim 15, wherein the input light beam is generated by an optical source comprising at least one comb laser that emits the input light beam.

17. The method of claim 11, wherein the input light beam is generated by an optical source comprising a plurality of comb lasers that emit the input light beam as a plurality of input light beams, each input light beam comprising a set of optical signals within a waveband of the plurality of wavebands.

18. An optical receiver comprising:
a first demultiplexer that splits a first modulated optical signal into a first plurality of post-demultiplexed optical signals, wherein the first modulated optical signal comprises first sets of modulated discrete optical signals within a plurality of wavebands, wherein each of the first plurality of post-demultiplexed optical signals comprises a set of the modulated discrete optical signals of the first sets of modulated discrete optical signals;
a plurality of waveguides that receive the first plurality of post-demultiplexed optical signals from the first demultiplexer, wherein the first sets of modulated optical signals are split amongst the plurality of waveguides according to the plurality of wavebands; and
sets of detectors optically coupled to the plurality of waveguides, wherein the sets of detectors comprise:
an optical detector that receives a post-demultiplexed optical signal of the first plurality of post-demultiplexed optical signals via a waveguide of the plurality of waveguides and drops the received post-demultiplexed optical signal at a wavelength corresponding to a resonance wavelength of the respective optical detector; and
a photodetector that detects the modulated post-demultiplexed optical signal from the optical detector to extract data imparted on the modulated optical signal,
wherein the plurality of wavebands comprise a waveband spacing that is based on a free spectral range of the optical detector.

19. The optical receiver of claim 18, wherein the waveband spacing is equal to or greater than a free spectral range of the optical detector.

20. The optical receiver of claim 18, further comprising:
a polarization beam splitter that splits the modulated optical signal into the first modulated optical signal having a first polarization state and a second modulated optical signal having a second polarization state; and
a second demultiplexer that splits the second modulated optical signal into a second plurality of post-demultiplexed optical signals, wherein the second modulated optical signal comprises second sets of modulated discrete optical signals within the plurality of wavebands, wherein each of the second plurality of post-demultiplexed optical signals comprises a set of the modulated discrete optical signals of the second sets of modulated discrete optical signals,
wherein the plurality of waveguides receive the second plurality of post-demultiplexed optical signals from the second demultiplexer according to the plurality of wavebands,
wherein the optical detector receives a post-demultiplexed optical signal of the second plurality of post-demultiplexed optical signals via the waveguide and drops the received post-demultiplexed optical signal at the wavelength corresponding to the resonance wavelength of the respective optical detector.
